(19) United States
(12) Patent Application Publication
(10) Pub. No.: US 2026/0154614 A1
(43) Pub. Date: Jun. 4, 2026

(54) SYSTEM AND METHOD FOR PREDICTION OF ARTIFICIAL INTELLIGENCE MODEL GENERALIZABILITY

(71) Applicants: Engin DIKICI, Columbus, OH (US); Luciano PREVEDELLO, Columbus, OH (US); Xuan NGUYEN, Columbus, OH (US); Ohio State Innovation Foundation, Columbus, OH (US)

(72) Inventors: Engin DIKICI, Columbus, OH (US); Luciano PREVEDELLO, Columbus, OH (US); Xuan NGUYEN, Columbus, OH (US)

(21) Appl. No.: 19/122,875

(22) PCT Filed: Oct. 20, 2023
(86) PCT No.: PCT/US2023/077382

§ 371 Date: Apr. 21, 2025

Related U.S. Application Data
(60) Provisional application No. 63/380,419, filed on Oct. 21, 2022.

(51) Int. Cl. G06N 20/00

(52) U.S. Cl. CPC G06N 20/00

(57) ABSTRACT

A method and system for training a machine learning or artificial intelligence classification model is presented herein. The method and further including steps for analyzing the generalizability of the trained model classifications and providing a related generalizability indication. A system for the same are also disclosed.

### CROSS-REFERENCE TO RELATED APPLICATIONS

This application claims the benefit of priority to U.S. Provisional Application No. 63/380,419 filed Oct. 21, 2022, the disclosure of which is incorporated herein by reference in its entirety.

### FIELD OF THE INVENTION

Embodiments of the present invention relate to prediction of artificial intelligence model generalizability.

### BACKGROUND

Model generalization or generalizability refers to a model's ability to operate properly to new, previously unseen data drawn from the one used to create the model. AI/NL generalizability is an area of interest for any AI/ML implementations as there is a desire to share and potentially broadly use the trained AI/ML model with non-identical data that are nevertheless similar but not identical in the manner that they were acquired to those used for the training. In the context of AI medical diagnostic applications (e.g., involving medical imaging data such as MRI, CT images, or the like), the AI model may be trained with one set of machines, having one set of protocols, patient population, and machine settings. The AI model may be later deployed to classify data acquired at different sites using different machines having different manufacturers, acquired with different protocols, and acquired with different machine settings.

Various metrics have been developed to assess generalizability, though they are insufficient to determine an existing model's generalizability for a novel test set. Model complexity is one metric to assess/predict its generalizability, though insufficient. Norms (e.g., trace, max, etc.) are considered as being sensible inductive biases in matrix factorization and are used, often because they are more appropriate than parameter-counting measures such as the rank. Sharpness (i.e., the robustness of the training error to perturbations in the parameters) as a complexity measure has also been explored.

There is a benefit to improving AI/ML model development for greater generalizability or generalizability assessment.

### SUMMARY

An exemplary AI system and method are described in which the generalizability of a trained AI model can be assessed for the continuity of its performance acquired from varying geographic, historical, and methodologic settings or configurations. The exemplary AI system and method is configured to map, or force, the training data's underlying statistical distribution into a pre-defined latent space statistical distribution that provides a measurable data statistical distribution to which subsequent novel, unseen data can be measured and assessed. The mapping operation during the training of the AI model can also be considered as an optimization problem to optimize the AI model's alignment of incoming data to be within a predefined distribution space (also referred to as a latent space statistical distribution) to which distances are tied to a latent space or have meaning with respect to generalizability.

One example of the latent space statistical distribution is a multivariate Gaussian though other distributions may be employed (e.g., chi-square, among others described herein). Latent space may be referred to as a representation of the compressibility, abstractability, or dimensionality reduction, of the pattern in the data in which similar data, or instances of the data, are closer together in space.

The assessment may be beneficially performed off-line during the development, training, testing, or validation of a model as well as on-the-fly. That is, during real-time operation to determine whether an input of a production model should be ranked with a low-confidence score because the input, through the generalizability assessment, is deemed to be novel/new and, thus, an outlier over the training data set used to create the trained AI model. To this end, rather than merely achieving high generalizability, e.g., via using larger datasets, transfer learning, data augmentation, and model regularization schemes, the exemplary AI system and method can assess, and improve when desired, when generalizability is achieved for a novel, unseen data used for the AI training.

In an aspect, a method is disclosed to train a machine learning or artificial intelligence (ML/AI) classification model, the method comprising receiving, by a processor, a training data set; training or re-training, by the processor, via a latent-space-associated loss function, a classification model (or a trained classification model) to generate a trained classification model (or a re-trained classification model), wherein the training or re-training applies a latent space mapping that adjusts parameters of the classification model that forced the training data set to a probabilistic distribution defined in the latent-space-associated loss function; and outputting, by the processor, the trained classification model, wherein the trained classification model is used in a classification application (e.g., diagnostics, controls, etc.).

In some embodiments, the training or re-training via the latent-space-associated loss function includes iteratively adjusting parameters of the classification model for a plurality of data in the training data set by, for a given data of the plurality of data: (i) calculating parameters of the probabilistic distribution (e.g., mean and covariance matrix for a Gaussian distribution or for a multivariate normal distribution); (ii) calculating the distance measure (e.g., Fréchet distance) between the probabilistic distribution and the given data; and (iii) penalizing a divergence from the probabilistic distribution proportionally.

In some embodiments, the method further includes evaluating, by a processor of a second computing device, a second data set by: (i) calculating the distance measure of the second data set in the probabilistic distribution; and (ii) comparing the probabilistic distribution of the second data set to the probabilistic distribution of the training data set, wherein the comparison is used to determine the second data set as an outlier of the training data set.

In some embodiments, the comparison determines whether the probabilistic distribution of the second data set is greater than a pre-defined deviation (e.g., 1-standard deviation, 2-standard deviation, user-defined, etc.) to the probabilistic distribution of the training data set.

In some embodiments, the evaluation causes the second computing device to at least one: (i) indicate the second data set as an outlier; (ii) indicate the second data set as having high confidence of being an outlier data set; and (iii) reject output of the trained classification model from the second computing device.

In some embodiments, the method further includes generating a report of the evaluation.

In some embodiments, the parameters of the probabilistic distribution include a mean parameter and a covariance matrix parameter for a Gaussian distribution.

In some embodiments, the distance measure is a Fréchet distance function.

In another aspect, a method is disclosed to generate a generalization metric for an AI classification model trained using data from a first measurement system, the method comprising receiving a data set for an AI model, wherein the data set was acquired from (i) a second measurement system type or (ii) a second measurement system having a different measurement protocol to that of the first measurement system; calculating a distance measure of the data set in a latent-space associated probabilistic distribution, wherein the AI classification model was trained in a training or re-training operation using a latent-space-associated loss function, wherein the training or re-training operation applies a latent space mapping that adjust parameters of the AT classification model that forced a training data set to the latent-space associated probabilistic distribution defined in the latent-space-associated loss function; determining a generalization metric by comparing the probabilistic distribution of the data set to the probabilistic distribution of the training data set; and outputting the determined generalization metric, wherein the generalization metric is used to at least one of (i) indicate the data set as an outlier, (ii) indicate the data set as having a high confidence of being an outlier data set, and (iii) reject output of the trained classification model.

In some embodiments, the training or re-training via the latent-space-associated loss function included: iteratively adjusting parameters of the classification model for a plurality of data in the training data set by, for a given data of the plurality of data: (i) calculating parameters of the probabilistic distribution (e.g., mean and covariance matrix for a Gaussian distribution); (ii) calculating the distance measure (e.g., Fréchet distance) between the probabilistic distribution and the given data; and (iii) penalizing proportionally a divergence from the probabilistic distribution.

In some embodiments, the parameters of the probabilistic distribution include a mean parameter and a covariance matrix parameter for a Gaussian distribution.

In some embodiments, the distance measure is a Fréchet distance function.

In another aspect, a system disclosed comprising a processor; and a memory having instructions stored thereon, wherein execution of the processor causes the processor to perform any one of the above-discussed methods.

In some embodiments, the training or re-training is performed on a first computing device, and wherein the generalization metric for an AT classification model is generated at a second computing device.

In another aspect, a non-transitory computer-readable medium is disclosed, having instructions stored thereon, wherein the instructions, when executed by a processor, cause the processor to perform any one of the above-discussed methods.

In another aspect, a product-by-process is disclosed comprising instruction code generated by processes of any one of the above-discussed methods of claims.

### BRIEF DESCRIPTION OF THE DRAWINGS

FIGS. 1A, 1B, and 1C each show an example AI system configured to train or retrain an AI classification model that can map or force the training data's underlying statistical distribution into a pre-defined latent space statistical distribution in accordance with an illustrative embodiment.

FIGS. 2A, 2B, 2C, and 2D each shows an example method 200a of generating a latent-space-measurable AI classification model.

FIGS. 3-10 provide a description and results of a conducted study in which:

FIG. 3. Simplified overview using 2D data and 2D latent space.

FIG. 4. Training of the BM framework. (A) Candidate BM positions are computed using a scale-space-based point detection methodology in 3D; (B) cubic regions centered by the positive (i.e., BM) and negative (i.e., not BM) candidate positions are compiled into paired batches, augmented, and iteratively fed into CropNet optimized using binary cross-entropy loss.

FIG. 5. The histograms for the BM count per exam (A), BM volume (B) and BM diameter (C) are shown for Train (ABC-1), Test OSU (ABC-2) and Test Stanford (ABC-3) groups.

FIG. 6. BM probability density function's projections on left sagittal (A), axial (B), and coronal (C) planes are provided for the Train (ABC-1), Test OSU (ABC-2) and Test Stanford (ABC-3) groups.

FIG. 7 and FIG. 8. The AFP vs sensitivity for (A) the combination of two test groups, (B) Test-OSU and (C) Test-Stanford. (1) The black curves: the complete set of exams; (2) the blue curves: the subgroup of exams where the model predicted that it generalizes; (3) the red curves: the subgroup of exams where the model predicted its low generalizability. FIG. 8 shows a table of the results.

FIGS. 9A-E. (A-1) The network's BM probability output is represented as a heat map for random candidate regions in latent space, (A-2) the decision curve is predicted based on the probability outputs, shown with an orange dashed curve. (B) Training, (C) Test-OSU, (D) Test-Stanford BM LSMs are shown with the predicted decision curve, and (E) mid-axial slices of a sample set of candidate cubic regions from the Test-Int group.

FIGS. 10A and 10B. The locations of the BM and the model's generalization status are overlayed on two different exams by an advanced DICOM viewer; (A) ‘model generalizes’ info is generated by the proposed algorithm, (B) ‘low model generalizability’ warning is generated by the proposed algorithm: the data was from another organization acquired with a scanner, where the training data had no acquisitions from a similar scanner.

FIGS. 11A and 11B. The system is shown for use in a diagnostic computing system and a control system.

### DETAILED SPECIFICATION

To facilitate an understanding of the principles and features of various embodiments of the present invention, they are explained hereinafter with reference to their implementation in illustrative embodiments.

### Example System

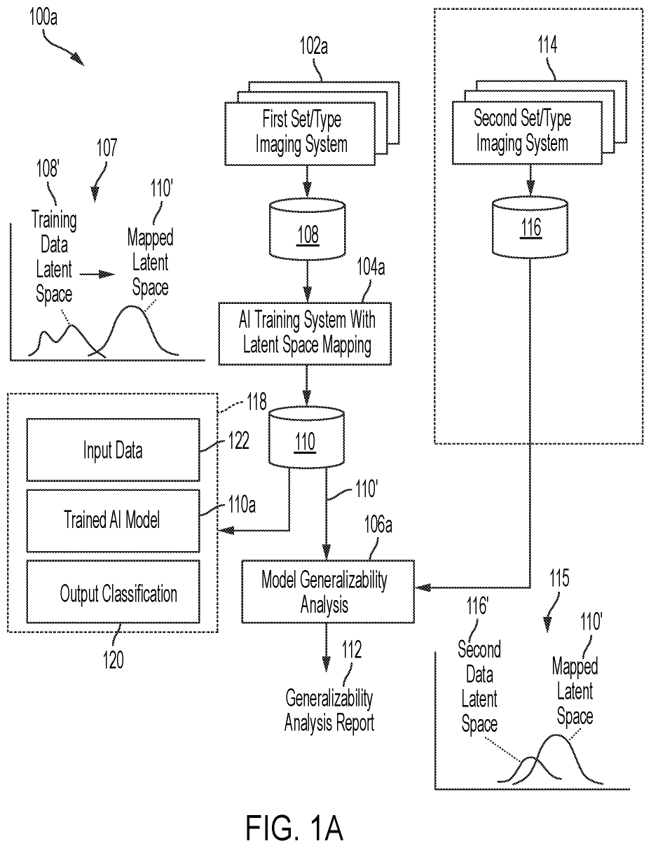

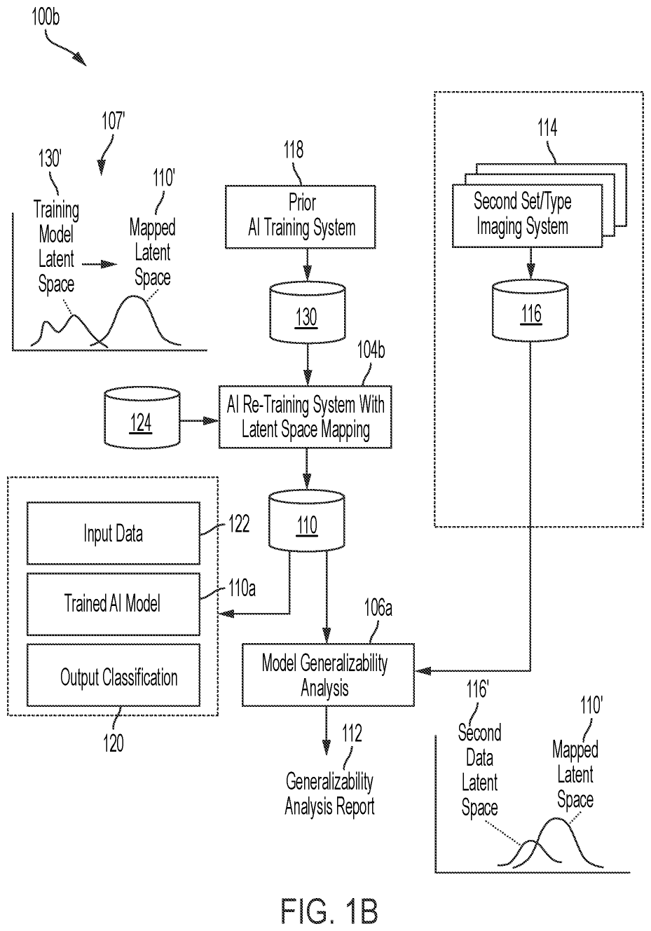

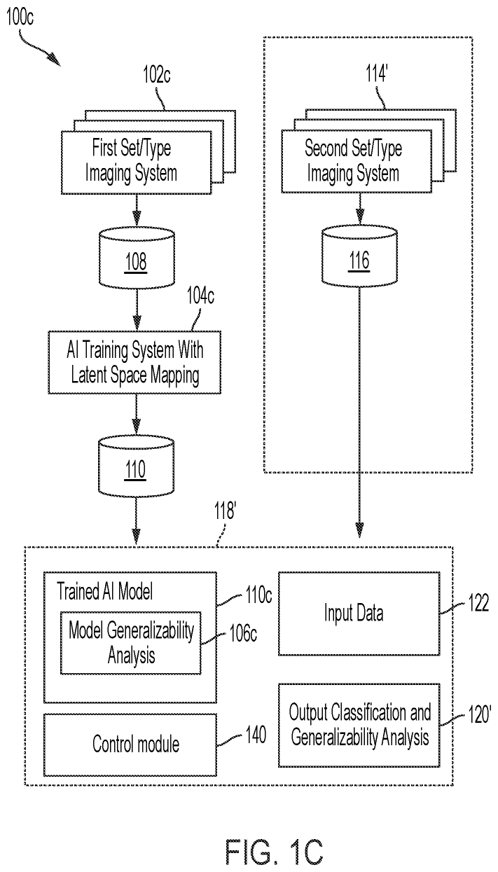

FIGS. 1A and 1B each show an example AI system 100 (shown as 100a and 100b, respectively) configured to train or retrain an AI classification model that can map or force the training data's underlying statistical distribution into a pre-defined latent space statistical distribution in accordance with an illustrative embodiment. The systems 100a, 100b can train (FIG. 1A) or retrain (FIG. 1B) the machine learning or artificial intelligence (ML/AI) classification model employing a training data set via a latent-space-associated loss function that adjust parameters of the classification model that forces the training data set to a probabilistic distribution defined in the latent-space-associated loss function.

In the example shown in FIG. 1A, the system 100a includes a first set or first type of device 102 (shown as a “First Set/Type Imaging System” 102a) configured to provide training data for a training module 104 (shown as “AI Training System With Latent Space Mapping” 104a) of an AI classification model and a generalizability analysis module 106 (shown as “Model Generalizability Analysis” 106a).

The first set or first type of measurement device 102a is configured to acquire measurements for a training data set 108 (shown in a datastore) that can be used to configure an AI classification model. The measurement system, in some embodiments, includes a medical/radiologic imaging system that is used for medical diagnostics, such as a CT, MRI, PET, or the like or a healthcare information system (HIS) configured to store electronic patient records. In other embodiments, the measurement system includes sensors for computer vision applications (e.g., autonomous vehicle, surveillance, security, robotics, factory automation, process automation, medical diagnostic application, finance, among other applications described herein).

The training module 104a is configured with a machine learning optimization operation that takes the training data set 108 to generate a prediction model as a classifier model 110 (shown as a datastore) by adjusting the weights of the classifier model. Common examples of machine learning optimization operation include AdaBoost, Random forest, XGBoost, Decision tree learning, and the like. The model is built in a stage-wise manner by allowing for the optimization of a loss function. Notably, the training module 104a includes a latent-space-associated loss function that is employed during the training process to map, or force, the training data's underlying statistical distribution into a pre-defined latent space statistical distribution.

One example of the latent space statistical distribution is a multivariate Gaussian distribution (also referred to as a normal distribution) though other distributions may be employed (e.g., multivariate t-distribution, Dirichlet distribution, multivariate stable distribution, among others described herein). In some embodiments, the distribution can be univariate (e.g., chi-squared).

Latent Space Mapping via AI Training or Re-Training. The generalizability of an AI model may be estimated by specifying the underlying data presentation held by the model. Domain shift is the cause of reduced generalizability [26], [41]; which describes a mismatch between the training and the new (i.e., test, unseen) data underlying probabilistic distribution functions (PDFs). Understanding the training data's PDF by observing the model's latent space is not an intuitive task, as the latent space mappings (LSMs) of modern AI (e.g., DNNs) are commonly not formulated to convey a specific distribution pattern. By forcing the training data, as employed in the training, into a predefined PDF held by the model during its training, then the unseen data PDF divergence from this distribution can be quantified, leading to a precursor for predicting the model's generalizability.

For example, for a training dataset x and a corresponding output y (with unknown PDFs of P(x) and P(y) respectively)), a trained classifier network (e.g., CropNet) can (1) map x into hidden layer outputs (i.e., LSMs) of z₁, z₂, . . . z_{d} with d giving the network depth, and (2) produce the network output \tilde{y} approximating y. The hidden layer PDFs are given by posterior distributions of p(z₁|x, y), p(z₂|x, y), . . . p(z_{d}|x, y), and the output PDF is given by p(y). Each [symbol] may give a form of underlying training data representation the model holds; however, the PDFs of the latter layers are more relevant as they represent the information distilled towards the target output. Accordingly, the posterior distribution p(z_{d}|x, y) can be referred to as the underlying training data presentation, and LSMs as the latent space mappings of layer d.

The trained classifier network may perform a binary classification task with the classes of “1”:disease state and “0”:No-disease state, where the positively labeled part of the training data can be shown as (x₊, y₊). By forcing the underlying representation of only the positive part of the training data, as the disease-state class is heavily underrepresented in this specific application, the candidate selection stage can generate or weight candidates for a given 3D dataset where only a minuscule amount of them are disease-state centers [42]. In some embodiments, the latent space associated loss function can be employed to force the underlying data presentation of the positive part into a standard multivariate normal distribution (i.e., with zero mean and identity covariance matrix) per Equation 1.

$$p ( {z}_{d +} \vert {x}_{+} , {y}_{+} ) \approx N ( 0 , I ) \qquad ( Eq . 1 )$$

In Equation 1, the training operation employs a Fréchet Loss Function (FLS) in the loss function that can be employed iteratively to perform the given approximation during the model's training. That is, for a given batch of samples from positive samples (z̅⊆z_{d+}), the FLS can (i) compute the mean (μ_{b}) and covariance matrix (Σ_{b}) of z̅ and (ii) return the Fréchet distance [43](d²) between the batch's distribution and the distribution N(0, I) per Equation 2.

$${d}^{2} = {\vert {μ}_{b} \vert}^{2} + tr ( {\sum }_{b} + I - 2 \cdot {( {\sum }_{b} + ε \cdot I )}^{1 / 2} ) \qquad ( Eq . 2 )$$

In Equation 2, the parameter ε can yield a small floating number to ensure that the square root of Σ_{b} could be computed. The parameter ε also penalizes proportionally the divergence of the posterior distribution from the distribution N(0, I). After the training, the standard multivariate normal distribution p(z_{d}+|x₊, Y₊) can be estimated via multivariate normal distribution N(μ_{f}, Σ_{f}) using the LSMs' final positions without a dimension reduction.

The training operation via the FLS optimizes the AI model to be within a predefined distribution space—namely, the latent space statistical distribution—to which distances are tied to a latent space or have meaning with respect to generalizability.

To this end, for a given unseen data (e.g., test data acquired with a production system), the underlying training data representation of the predicted positive samples (i.e., pseudo positives) can then be analyzed. In an example, the Mahalanobis distances between LSMs coming from pseudo-positive samples \tilde{z} (with the corresponding network output of \tilde{y}>ψ), where ψ is a network threshold calibrated for a specific disease-state detection sensitivity based on the training data) and the forced distribution (i.e., N(μ_{f}, Σ_{f})) can be computed to give a set of new data D. Finally, the hypothesis that the majority of new data D are not outliers with regards to the forced distribution can be tested by comparing the median of new data D versus a high quantile (i.e., 95%) chi-square distribution with degrees of freedom given by dim(μ_{f}). If the majority of \tilde{z} are outliers, then the given unseen data can be classified as being different from the training data in its underlying presentation characteristics; thus, the model would be provided a low score for generalizability.

Diagram 107 shows an example representation of the latent space of the training data set 108′ (shown as “Training Data Latent Space” 108′) to which the training operation via the latent-space-associated loss function forces the representation of the training data into a mapped latent space statistical distribution 110′ (shown as “Mapped Latent Space” 110′). Diagram 115 shows an example representation of the latent space of the new data set 116′ (shown as “Second Data Latent Space” 116′) that can be computed by forcing the new data set 116 into the same latent space for a comparison with the mapped latent space statistical distribution 110′ of the training data set. The diagrams 107 and 115 are merely representations of one example of the statistical distribution information. During run-time, it should be understood that the diagrams (e.g., 107, 115) or the representation distribution may not have to be generated. For example, for the Gaussian distribution, the analysis of the comparison can be performed using mean and covariance matrix values between the two distributions.

Mahalanobis distance is a measure of the distance between a point P and a distribution D. In addition to the Mahalanobis distances, other distance metrics (e.g., Euclidean, Manhattan, Minkowski distances, and the like) may be employed to determine whether the latent space statistical distribution of the new data set 116′ is an outlier of the latent space statistical distribution of the training data set 110′.

Referring still to FIG. 1A, subsequent to the model training and the generation of the trained AI classification model 110a, model 110 is stored and can be provided in a production site or operation. In some embodiments, the AI classification model 110 is employed in a classification operation with respect to a second set or second type of data. The second set or second type of measurement device 114 is configured to acquire measurements for a new data set 116 (shown in a datastore) to which the data set can be applied to the trained AI model 110a to generate a classification output. The measurement system 114, in some embodiments, is similar but not identical to the first set of the first type of measurement system 102, though it may be in the same class of devices. In some embodiments, the second measurement system 114 may be entirely different from the first measurement system 102 but both are employed to generate similar feature sets.

In the example shown in FIG. 1A, the generalizability analysis module 106a is configured to (i) receive the mapped latent space statistical distribution 110′ (e.g., from the datastore) and (ii) compute a distance measure of the new data set 116 in the latent-space associated probabilistic distribution 116′ (an example shown in diagram 115). The generalizability analysis module 106a can then compare, e.g., via a T-test or other test described herein, the latent-space associated probabilistic distribution 116′ of the new data set 116 to the mapped latent space statistical distribution 110′ to the training data set 110. The generalizability analysis module 106a generates an output report 112 (shown as “Generalizability Analysis Report” 112). Based on the output, the AI classification model 110 (shown as 110a) is employed in a production application 118 to generate an output classification 120 based on a provided data set 122. In some embodiments, the AI classification model 110a is configured to operate in the production application 118 in combination with the generalizability analysis module 106a in which the generalizability analysis module 106a, concurrent with the model output 120, provides a measure or a score that the data set 122 either (i) is an outlier of the training data set, (ii) indicates a high confidence value that the data set 122 is an outlier data set, and/or (iii) rejects the output 120 of the trained classification model from being subsequently used. In some examples, the measure or score of the data classification confidence is displayed as a generalization indicator of the former ranges (i), (ii), or (iii).

AI Re-training system. FIG. 1B shows the re-training module 104 (shown as “AI Re-Training System With Latent Space Mapping” 104b) configured to re-train a previously trained classification model 130 to make the model 130 measurable in a pre-defined latent space statistical distribution. The re-training module 104b is configured to map, or force, the statistical distribution of the trained configuration of the previous trained model 130 (shown in a datastore) into the pre-defined latent space statistical distribution 110” (see diagram 107′). In the example shown in FIG. 1B, the re-training module 104b receives a previously trained AI classification model 130 having a latent space statistical distribution 120′ (shown as “Trained Model Latent Space” 130′). The re-training module 104b retrains the AI classification model 130 with train data set 124 (e.g., where the training data set 124 can include previously used data set in the initial training or new data set) to adjust, via a latent-space-associated loss function, parameters of the previously trained classification model 130 to force its trained configuration to the probabilistic distribution defined in the latent-space-associated loss function.

In diagram 107′, the latent space of the trained configuration 130′ is shown mapped/forced into the mapped latent space statistical distribution 110′. Once mapped to the prescribed latent space statistical distribution, the generalizability analysis, e.g., of module 106a, as described in relation to FIG. 1A, may be employed.

AI Runtime system. FIG. 1C shows an example implementation of the generalizability module as part of trained AI model. The production application, 118′, of the system 100c includes the input data 122, the trained AI model 110c together with the model generalizability analysis 106c, a control module 140, and the output classification and generalizability analysis 120′.

In some embodiments, the trained AI model 110c is configured to operate in the production application 118′ in combination with the generalizability analysis module 106c in which the generalizability analysis module 106c, concurrent with the model output 120′, provides a measure or a score that the input data 122 either (i) is an outlier of the training data set, (ii) indicates a high confidence value that the data set 122 is an outlier data set, and/or (iii) rejects the output 120 of the trained classification model from being subsequently used. In some examples, the measure or score of the data classification confidence is displayed as a generalization indicator of the former ranges (i), (ii), or (iii). The control module 140 is configured to receive and transmit the output 120′ via display or communication relay means.

The trained AI model 110c determines a latent space distribution value for an input data. The latent space distribution value can then be compared to a provided threshold to determine whether the input is within the distribution of the training data set. By being in the provided distribution, e.g., as defined by the threshold, there is high confidence that the trained AI model 110c would operate as intended with the model being generalized for that input data.

In an example of the system 100c, an autonomous vehicle-control system may include the system 100c, wherein the vehicle sensors and cameras provide input images. For example, consider an AI training system that has been trained via the latent space mapping training system 104c. Then the autonomous vehicle, operating with the system 100c, provides the second set of images 116, which are passed to the production application 118′. The trained AI model 110c infers the classification of the input data provided by the operating autonomous vehicle and the model generalizability analysis provides a generalization indicator which may imply the confidence the autonomous vehicle may have in the classification. The output 120′ is then transmitted/displayed via the control module, which may operate on the autonomous vehicle. For instance, if the confidence in the classification of an object detected by the autonomous vehicle is low, then the control module may indicate the confidence and initiate for control of the autonomous vehicle to be given back to the vehicle operator. It should be understood that the control module 140 as described in this example is for example only.

The control module 140 may be configured to provide the desired functionality for the application in which the system 100c is applied. In another example, the control module may be configured to regulate electric flow or power in a hardware system.

### Example Method of Operation

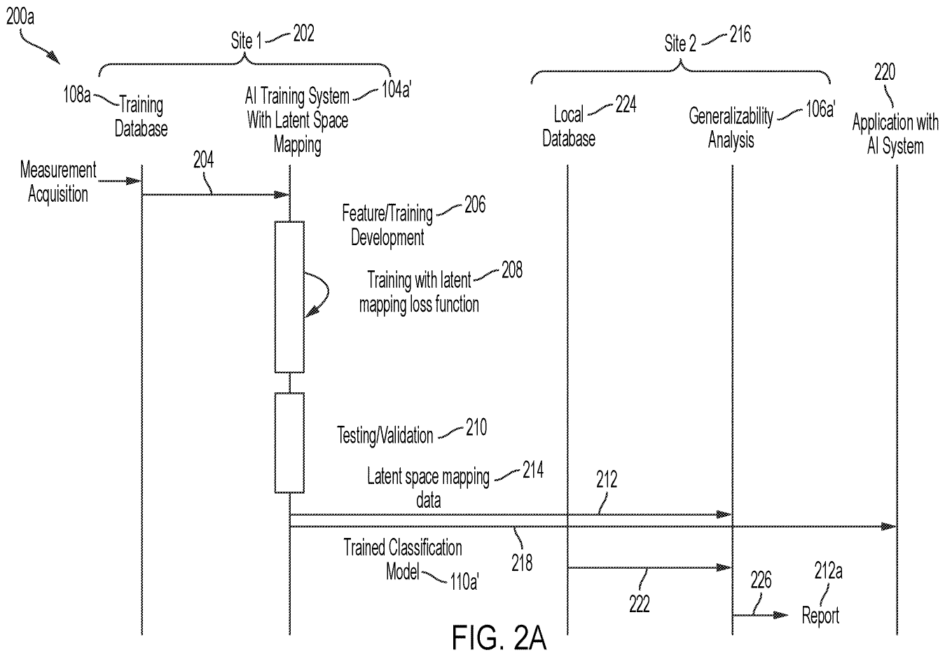

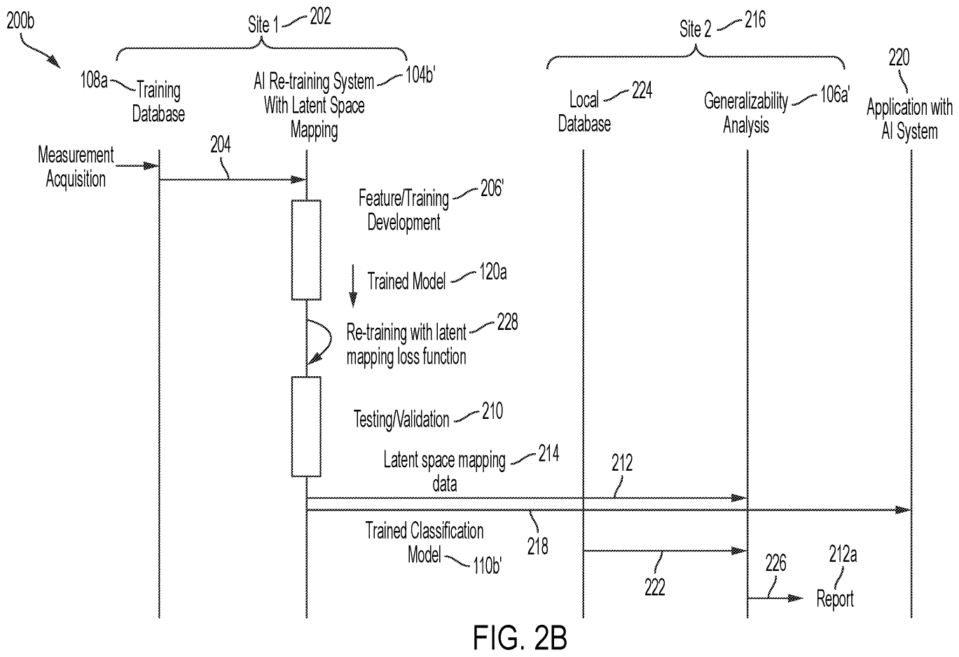

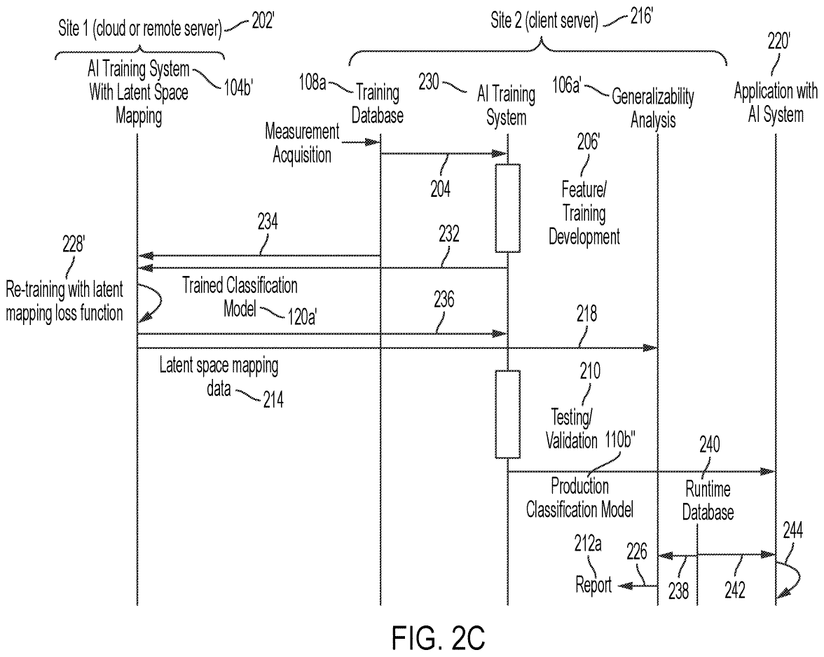

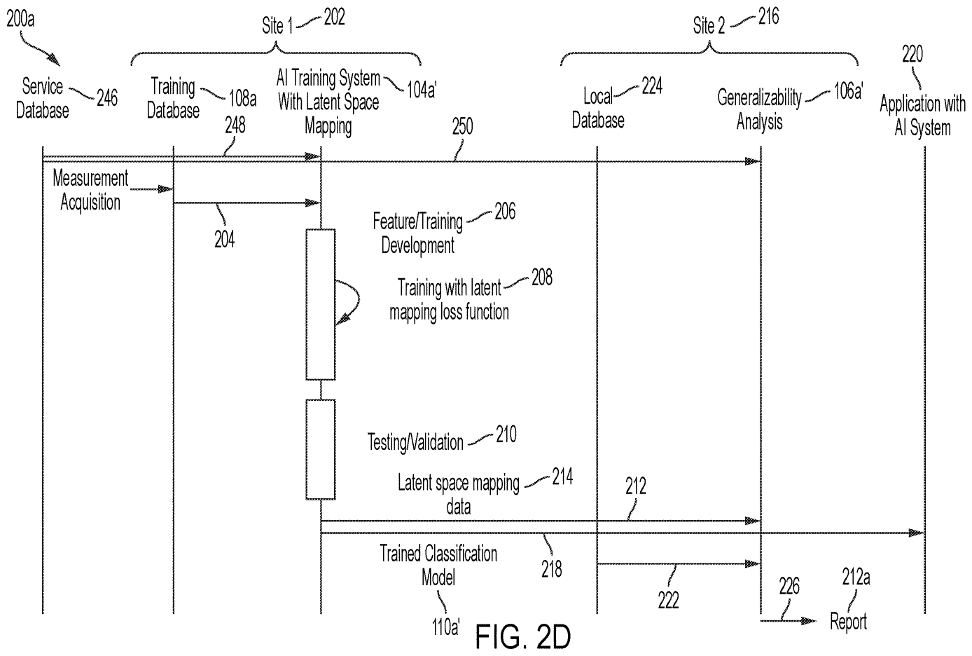

FIGS. 2A, 2B, 2C, and 2D each show an example method 200 (shown as 200a, 200b, 200c, and 200d) of assessing the generalizability of an AI classification model and/or usage of the assessed generalizability measure of the model to inform a user of the usage of the AI classification model in a classification application (e.g., diagnostics, controls, etc.).

Method Example #1. FIG. 2A shows an example method 200a of generating a latent-space-measurable AI classification model (e.g., 110). In the example of FIG. 2A, a training database 108a, located at site 202 (shown as “Site 1” 202), provides (204) training data set (e.g., 108) to a training module 104a (shown as “AI Training System With Latent Space Mapping” 104a′). The training module 104a′ performs 206 (i) feature calculation and/or development and/or (ii) training of an AI classification model 110a′ (operation shown as “Feature/Training Development” 206). During the training operation 206, the classification model is trained (208) using the latent-space-associated loss function, e.g., as described in relation to FIG. 1A or 1B. Subsequent to training (e.g., 206, 208), the AI classification model 110a′ is evaluated 210 using testing and verification (shown as “Testing/Validation” 210). The training module 104a′ (or a component operating therewith) can then provide (212) the latent space mapping data 214 to a generalizability analysis module 106a′ (shown as “Generalizability Analysis” 106a′), shown in the example executing at a second site 216 (shown as “Site 2” 216), as well as provide (218) the AI classification model 110a′ (shown as “Trained Classification Model” 110a′) to an application system 220 (shown as “Application with AI System” 220). The application system 220 may be located at site “2” (216) or a remote site.

At site “2”, the generalizability analysis module 106a′ receives (222) data from a local database 224 to compute the distance measure (e.g., Mahalanobis, Euclidean, Manhattan, Minkowski distance, etc.) of the new data set of database 224 in the latent-space associated probabilistic distribution (e.g., 110′ or 110”). Based on that computed distance measure, the generalizability analysis module 106a′ is configured to generate (226) a report 212a that can include (i) an indication that the data set is an outlier, (ii) an indication that the data set of database 224 has a high confidence of being an outlier data set, and/or (iii) a rejection output for the trained classification model 110a′.

Training can be supervised, semi-supervised, and unsupervised learning models. In a supervised learning model, the model learns a function that maps an input (also known as feature or features) to an output (also known as target or target) during training with a labeled data set (or dataset). In an unsupervised learning model, the model learns a function that maps an input (also known as feature or features) to an output (also known as target or target) during training with an unlabeled data set. In a semi-supervised model, the model learns a function that maps an input (also known as a feature or features) to an output (also known as a target) during training with both labeled and unlabeled data.

Representation learning refers to a subset of machine learning that enables a machine to automatically discover representations needed for feature detection, prediction, or classification from raw data. Representation learning techniques include, but are not limited to, autoencoders and embeddings.

Deep learning refers to a subset of machine learning that enables a machine to automatically discover representations needed for feature detection, prediction, classification, etc., using layers of processing. Deep learning techniques include, but are not limited to, artificial neural networks or multilayer perceptron (MLP). Artificial neural networks (ANN) are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. It should be understood that an artificial neural network is provided only as an example machine learning model.

A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., error such as L1 or L2 loss), during training. This disclosure contemplates that any algorithm that finds the minimum of the cost function can be used. LR classifiers are known in the art and are therefore not described in further detail herein.

An Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is a supervised classification model that classifies new data points based on similarity measures (e.g., distance functions). The k-NN classifiers are trained with a data set (also referred to herein as a “dataset”) to maximize or minimize an objective function, for example, a measure of the k-NN classifier's performance, during training. This disclosure contemplates that any algorithm that finds the maximum or minimum of the objective function can be used. The k-NN classifiers are known in the art and are therefore not described in further detail herein.

Training using the latent-space-associated loss function can be subsequent to or in combination with the above-discussed training (e.g., supervised, semi-supervised, unsupervised training, representation learning, deep learning, or other training operation described herein.

Method Example #2. FIG. 2B shows another example method 200b for generating a latent-space-measurable AI classification model. In the example of FIG. 2B, an AI classification model is re-trained to generate the latent-space-measurable AI classification model 110b′.

In FIG. 2B, a training database 108a, located at site 202 (shown as “Site 1” 202), provides (204) training data set (e.g., 108) to a re-training module 104b′ (shown as “AI Re-training System With Latent Space Mapping” 104b′). The re-training module 104b′ performs 206′ (i) feature calculation and/or development and/or (ii) training of an AI classification model 120a (operation shown as “Feature/Training Development” 206′).

Subsequent to the initial training 206′, the re-training module 104b′ (or a component operating therewith) can re-train 228 the trained classification model 120a using the latent-space-associated loss function, e.g., as described in relation to FIG. 1A or 1B. In the example shown in FIG. 2B, subsequent to training, the AI classification model 110b′ is evaluated 210 using testing and verification (shown as “Testing/Validation” 210). In other embodiments, the retraining operation 228 may be performed after testing and verification 210.

Similar to the operation described in relation to FIG. 2A, following training, the re-training module 104b′ can provide (212) the latent space mapping data 214 to a generalizability analysis module 106a′ shown in the example executing at a second site 216 as well as provide (218) the AI classification model 110b′ to an application system 220, e.g., located at site “2” (216) or a remote site.

At site “2”, the generalizability analysis module 106a′ receives (222) data from a local database 224 to compute the distance measure of the new data set in database 224 in the latent-space associated probabilistic distribution (e.g., 110′ or 110”). Based on that computed distance measure, the generalizability analysis module 106a′ generate (226) a report 212a that includes (i) an indication that the data set is an outlier, (ii) an indication that the data set of database 224 has a high confidence of being an outlier data set, and/or (iii) a rejection output for the trained classification model 110b′.

Method Example #3. FIG. 2C shows another example method 200c of generating a latent-space-measurable AI classification model. In the example of FIG. 2C an AI classification model is re-trained at an external server, e.g., a cloud server or remote server, to generate the latent-space-measurable AI classification model 110b′.

In FIG. 2C, a training database 108a, located at a site 216′ (shown as “Site 2 (client server)” 216′), provides (204) training data set (e.g., 108) to a training module 230 (shown as “AI Training System” 230). The training module 230 performs 206′ (i) feature calculation and/or development and/or (ii) training of an AI classification model 120a′ (operation shown as “Feature/Training Development” 206′). Subsequent to the initial training 206′, the client-server 216′ transmits (232), e.g., over a network, the trained AI classification model 120a′ to a re-training module 104b” (shown as “AI Re-training System With Latent Space Mapping” 104b”) executing at a second site 202′ (shown as “Site 1 (cloud or remote server)” 202′), and the training database 108a may provide (234) the training data (e.g., 108), or a portion thereof, to the re-training module 104b”. The second site 202′ may be implemented as a server in a cloud-based infrastructure or a remote server.

The re-training module 104b” (or a component operating therewith) can re-train 228′ the trained classification model 120a′ using the latent-space-associated loss function, e.g., as described in relation to FIG. 1A or 1B. In the example shown in FIG. 2C, subsequent to training (e.g., 228′), the cloud or remote server 202′ can provide (236) the latent-space measurable AI classification model 110b” to the client-server 216′ (shown in the example, to the training module 230) to perform the testing validation 210. Subsequent to testing and validation (210), the latent-space measurable AI classification model 110b” as the production classification model 110b” to the application system 220′, e.g., located at site “2” (216) or a remote site.

At the client-server 216′, the generalizability analysis module 106a′ can receive (218) the latent space mapping data 214 from the cloud or remove server 202′ and also receive (238) data from a local database 240 (shown as “Runtime Database” 240) to compute the distance measure of the new data set in database 240 in the latent-space associated probabilistic distribution (e.g., 110′ or 110”). Based on that computed distance measure, the generalizability analysis module 106a′ can generate (226) a report 212a that includes (i) an indication that the data set is an outlier, (ii) an indication that the data set of database 224 has a high confidence of being an outlier data set, and/or (iii) a rejection output for the production classification model 110b”.

Run-time Evaluation. In some embodiment, the run-time data can be evaluated on-the-fly to determine whether a new data set is an outlier. In the example shown in FIG. 2C, the runtime database 240 can provide (242) the new data set to the application system 220′, which can perform (244) the generalizability analysis and compute the distance measure of the new data set in database 240 in the latent-space associated probabilistic distribution (e.g., 110′ or 110”). Based on that computed distance measure, the application system 220′ can, e.g., reject the output for the production classification model 110b”.

Method Example #4. FIG. 2D shows another example method 200d of generating a latent-space-measurable AI classification model. In the example of FIG. 2D, a service database 246, e.g., located on cloud infrastructure or a local computing device, can (i) provide (248) instruction code of the training module 104a′ (shown as “AI Training System With Latent Space Mapping” 104a′) to site 202 to perform the generating of the latent-space-measurable AI classification model 110a′ and (ii) provide (250) instruction code of generalizability analysis module 106a′ to site 216. The instruction code for the training module 104a′ and generalizability analysis module 106a′ are then used to perform the operation as described in relation to FIG. 2A.

In some embodiments, the instruction code is provided as a library file or code snippet that can incorporated into the training files for an AI classification model.

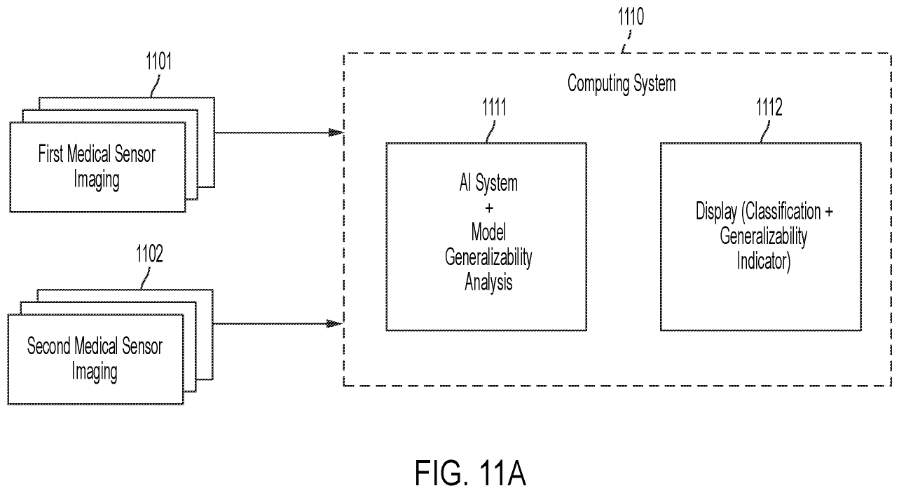

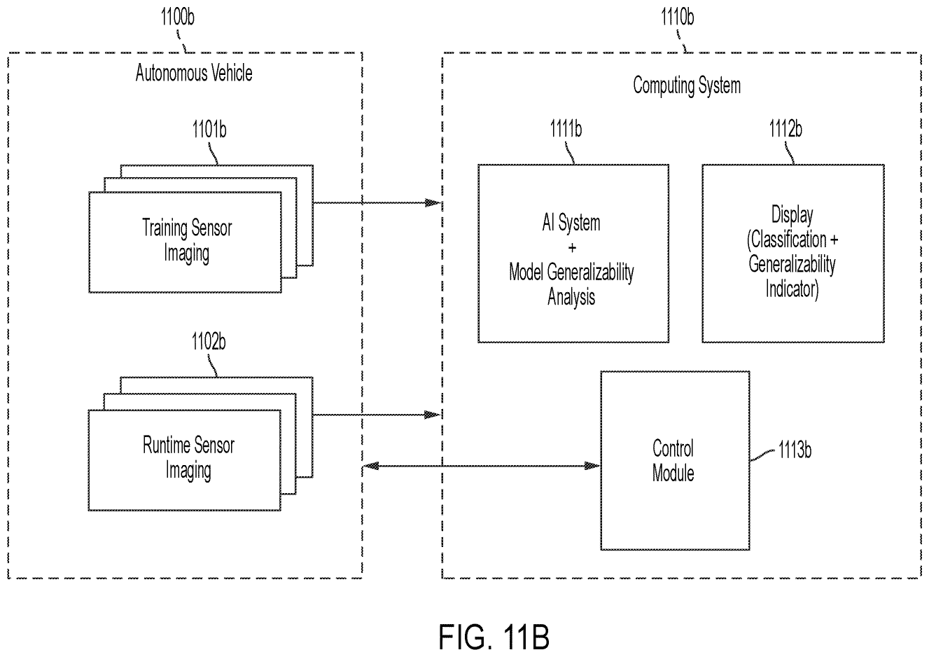

Example Implementation Systems. The AI system and methods disclosed herein may be implemented in a variety of classification and control systems. FIG. 11A shows an implementation of the AI system and model generalizability analysis in a medical image classification system. In this example, a first medical sensor imaging device 1101 provides images to the computing system (i.e. a first set of images), which may be training images. The medical sensor imaging device may provide ultrasound, CT, PET, MRI, and other radiological images The computing system 1110 includes an AI system and model generalizability analysis 1111 and a display 1112, which displays the classification and generalizability indicator from the AI system and model generalizability analysis 1111. A second medical sensor imaging device 1102, provides runtime images to the computing system, wherein the computing system, including the AI system and model generalizability analysis 1111, infers the classification of the second image set and the associated generalizability indication, which are displayed on the computing system. In various embodiments, the first and second medical sensor imaging devices may be the same or different.

FIG. 11B shows an implementation of the AI system and model generalizability analysis in a control system, which may be an autonomous driving control system. In this example, an autonomous vehicle 1100b provides training sensor imaging 1101b to the computing system 1110b. The sensors may include optical sensor, temperature sensor, acoustic sensor, pressure sensor, distance sensors, or flow sensor. The computing system 1110b includes an AI system and model generalizability analysis 1111b, a control module 1113b, and a display 1112b, which displays the classification and generalizability indicator from the AI system and model generalizability analysis 1111b. The control module 1113b receives the classification and generalizability indicator results and relays communication between the computing system 1110b and the autonomous vehicle 1100b. Runtime sensor imaging 1102b is provided to the computing system, wherein the computing system, including the AI system and model generalizability analysis 1111b, infers the classification of the second image set and the associated generalizability indication, which are displayed on the computing system and transmitted through the control module 1113b to the autonomous vehicle 1100b.

Example Machine Learning and AI. In addition to the disclosed AI/ML algorithms, other AI/ML algorithms can be employed in addition to those described herein.

Machine Learning. The term “artificial intelligence” (e.g., as used in the context of AI systems) can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks.

NeuralNetworks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. Graph convolutional neural networks (GCNNs) are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of cost function can be used. LR classifiers are known in the art and are therefore not described in further detail herein.

An Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is a supervised classification model that classifies new data points based on similarity measures (e.g., distance functions). The k-NN classifiers are trained with a data set (also referred to herein as a “dataset”) to maximize or minimize a measure of the k-NN classifier's performance during training. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Experimental Results and Additional Examples

Prediction of Model Generalizability for Unseen Data: Methodology and Case Study in Brain Metastases Detection in Ti-Weighted Contrast-Enhanced 3D MRI

A study was conducted to develop a BM detection framework for 3D-MRI Tic data. The study developed a deep neural network formulation that can enable the model to predict its generalizability status for unseen data. The training data was projected to a standard multivariate normal distribution using a loss function computing batch data statistics. The validation was performed using T1-Weighted Contrast-Enhanced 3D MRI data collected from multi-institutional resources.

Study Background: A medical AI system's generalizability describes the continuity of its performance acquired from varying geographic, historical, and methodologic settings. Previous literature on this topic has mostly focused on “how” to achieve high generalizability (e.g., via larger datasets, transfer learning, data augmentation, and model regularization schemes) with limited success. Instead, the study aim ed to determine “when” the generalizability is achieved: The study confirms that a medical AI system employed in the study could estimate its generalizability status for unseen data on-the-fly.

While the approach is applicable for most classification deep neural networks (DNNs), the study evaluated the system via brain metastases (BM) detector for T1-weighted contrast-enhanced 3D MRI. First, the study introduced a latent space mapping (LSM) approach utilizing Fréchet distance loss to force the underlying training data BM distribution into a multivariate normal distribution. During the deployment, a given test data's LSM distribution was processed to detect its deviation from the forced distribution; hence, the BM detector could be able to predict its generalizability status for a given unseen data set. If the reduced model generalizability was detected, then the user was informed by a warning message integrated into a sample radiology workflow.

The BM detection model was trained using 175 T1c studies acquired internally (by the OSU, College of Medicine) and validated using (1) 42 internally acquired T1c exams and (2) 72 T1 gradient-echo post images from Stanford University School of Medicine Brain Mets Dataset. The model predicted its generalizability to be low for 31% of the testing data (i.e., 2 OSU and 33 Stanford studies), where it produced (1) ˜13.5 false positives (FPs) at 76.1% BM detection sensitivity for the low and (2)˜10.5 FPs at 89.2% BM detection sensitivity for the high generalizability groups respectively. These results suggested that the proposed formulation enables a model to predict its generalizability for unseen data.

Discussion Artificial intelligence (AI) has been utilized immensely in medical applications over the last few decades [1], where significant progress in deep neural networks (DNNs) caused further momentum in the field [2]. Recently developed AI applications (e.g., in diagnostics [3]-[5], prognostics [6]-[8], and treatment response prediction [9]-[11]) represent a giant leap forward from their counterparts only a few years ago; however, their widespread adoption is still restricted due to their limited generalizability [12]-[14]. Generalizability of an AI system is a broad concept; describing the continuity of its performance when the data is coming from varying (1) geographic (e.g., institutions), (2) historical (e.g., timeframes), and (3) methodologic (e.g., acquisition parameters) settings [15]. Accordingly, its limitation refers to a drop in AI performance over time or when the deployment occurs across institutions with heterogeneous populations and imaging protocols [16].

In [17], generalizability in clinical research was presented as a hard-to-achieve goal, even as a myth, due to substantial context differences between institutions (caused by site-dependent items such as cohorts of patients and acquisition tools). The authors suggested that instead of seeking geographically generalizable tools, the research community should prioritize understanding how, when, and why their AI systems work. Nonetheless, there is optimism about addressing AI system's generalizability target during its development stage; [18] presented a weak correlation between the generalizability and a DNN's complexity (described using metrics such as its network size, norms, and sharpness). In their study, Eche et al. [16] identified the major causes of reduced generalizability in medical imaging systems as (1) overfitting (i.e., the AI-model learns unnecessary residual variations; information only applicable to training data [19]) and (2) underspecification (i.e., AI-model fails to learn the complete underlying statistical presentation of the data [20]). They argued that stress tests to evaluate a system's performance on shifted (i.e., generated via modifying data resolution or simulating different reconstruction kernels) or stratified datasets could enable the selection of models with reduced underspecification, where the solution was demonstrated on an AI model detecting hepatic steatosis in Computed Tomography (CT) datasets. The overfitting problem and its implications on AI-based radiology applications were further investigated in [21]. The study suggested that data augmentation [22], transfer learning [23], and model regularization [24] methods may alleviate the issue, whereas external validations are necessary before a system's incorporation into clinical use to ensure its generalizability. In [14], the data heterogeneity between populations (i.e., clusters) was presented as a cause of reduced generalizability. It utilized electronic health records (EHR) to measure cluster heterogeneities and adopted internal-external cross-validation [25] to produce a multi-site model predicting the risk of atrial fibrillation from clinical data. Thus, the approach is only applicable when (1) the participant data (or EHR) is available and (2) the sites are willing to share, train, and update their models synchronously.

From a statistical perspective, the reduced generalizability can rise due to a mismatch between the probabilistic distributions of training and testing datasets: a phenomenon referred to as the domain shift [26]. As DNNs are data-driven models, large and representative [27] training datasets could mitigate the aforementioned causes of the domain shift [28]. While there are public medical image databases [29] with many thousands of images (e.g., [30], [31]), (1) the number of datasets focusing on specific modalities and medical conditions is limited [32], and (2) widely used DNNs (e.g., [33], [34]) have many millions of trainable parameters; making generalizability unattainable in many clinical scenarios [35].

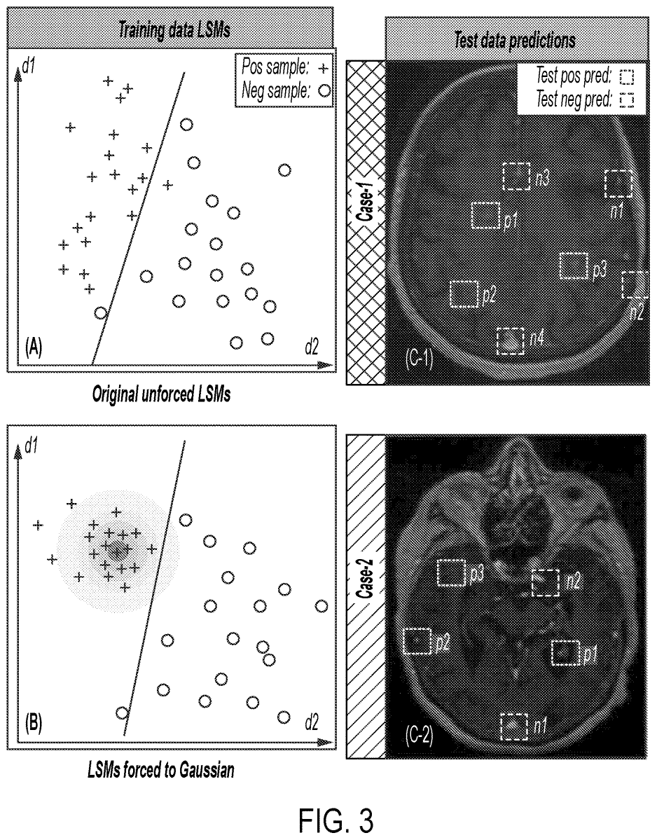

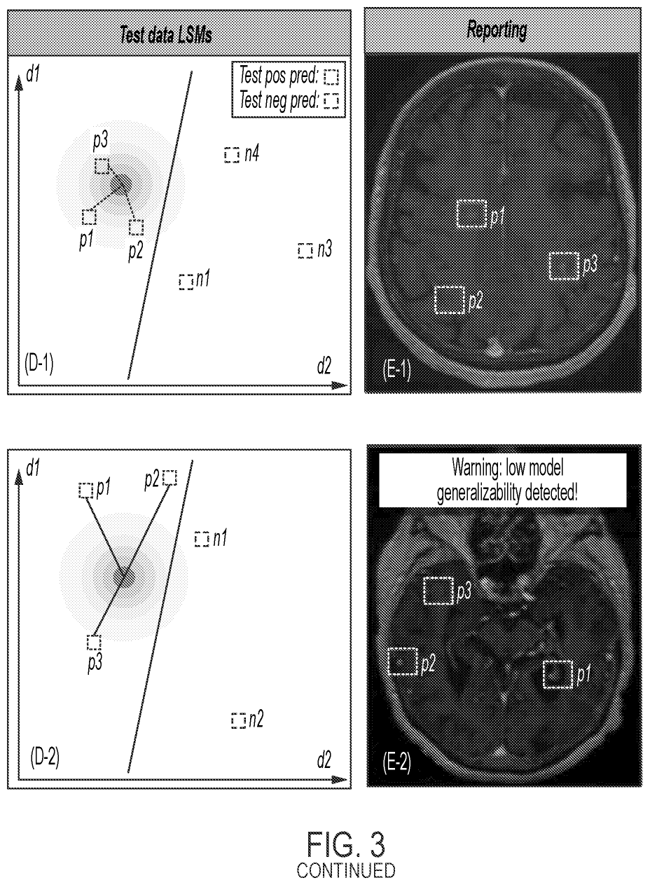

Unless (1) massive medical datasets with complete representativeness (in historical, geographical, and methodical domains) are built or (2) a wide range of institutions enter into agreements to train their medical AI models in harmony for the foreseeable future, a generalizability problem will be present. Adopting the skepticism raised by [17], the study did not propose yet another approach that may provide limited or conditional generalizability. Instead, the study's motivation is to introduce an AI model that is self-aware of its temporal generalizability status (i.e., for a given unseen data); enabling real-time warnings when the deployed model's generalizability is expected be low for a given exam. Hence, the study aimed to understand “when” an AI model is generalizable rather than taking blind shots at the broad problem of “how” to attain it, as previous literature on the topic has done. Our study introduces an AI-model formulation enabling the detection of reduced model generalizability for the given exam (i.e., temporal, on-the-fly), which may be occurring due to under-specification, overfitting, or other issue(s). The study provided (1) a latent space mapping (LSM) approach to force training data into a known probabilistic distribution during the model training, (2) the detection of reduced generalizability by processing test data LSMs, and (3) a sample integration of the reduced generalizability flag into an existing radiology workflow (see FIG. 3).

The validation study is presented for a brain metastases (BM) detector for T1-weighted contrast-enhanced 3D MRI (Tic).

FIG. 3: A simplified 2D representation of the latent space of multiple tumor candidates used to train a standard deep neural network; (A) in which positive (+) and negative (o) tumor candidates can be near-completely differentiated by a hyperplane that separates these, where the distribution does not follow a known statistical form, and (B) in which (+) candidates are mapped to a multivariate normal distribution. (C-E) During the inference, if the majority of the (+) candidates are not outliers (p1-p3 on image D-1), the model predicts that it generalizes for the case: Case 1 (C-1 through E1). If the majority of the (+) candidates are outliers with regards to the forced-Normal distribution (p1-p3 on image D-2), the model predicts that it has low generalizability for the case: Case-2 (C-2 through E2). In the event of low generalizability, the system displays a warning message to emphasize its uncertainty (E-2).

The validation used (1) training data from 175 internally acquired T1c studies and (2) testing data from 42 internally acquired Tic and 72 T1 gradient-echo post images from Stanford University School of Medicine Brain Mets Dataset [36]. Finally, it concludes with a discussion on analyses, limitations, and future work pointers.

### Materials and Methods

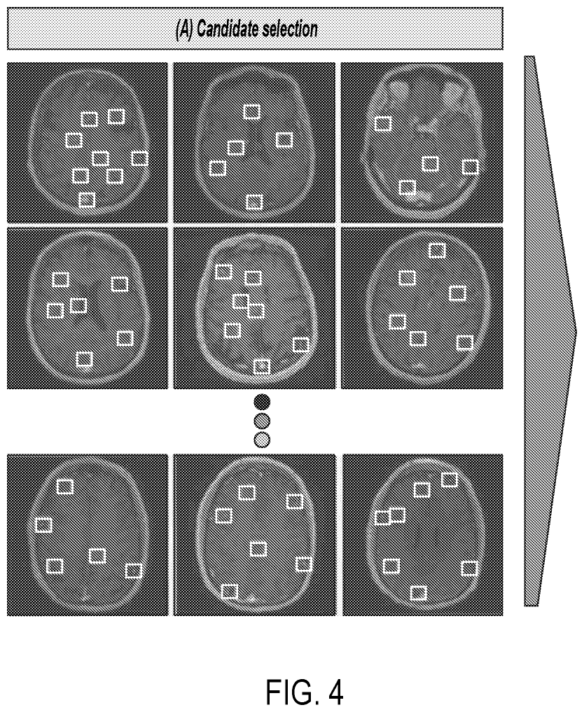

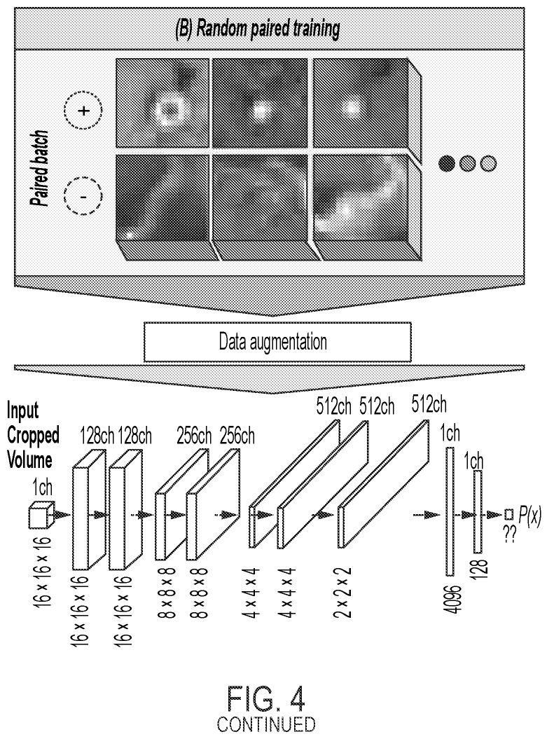

BM detection framework overview. FIG. 4. Training of the BM framework. (A) Candidate BM positions are computed using a scale-space-based point detection methodology in 3D; (B) cubic regions centered by the positive (i.e., BM) and negative (i.e., not BM) candidate positions are compiled into paired batches, augmented, and iteratively fed into CropNet optimized using binary cross-entropy loss.

A framework was introduced in [37] with the goal of detecting smaller BM (<15 mm) in 3D T1c datasets, which remains a challenging task due to the tumors' (1) smaller dimensions, (2) low contrast with surrounding tissues, and (3) visual similarities with vascular structures in some slice angles in T1c [38]. It consisted of two stages: (1) candidate selection and (2) classification of the candidates as BM or not. The candidate selection stage adapted the scale-space point detection approach from [39] by integrating a minimax optimization to maximize the BM detection sensitivity while minimizing false-positive tumor detections. The classification stage employed a dedicated classification neural network called CropNet to differentiate BM from other candidates in 3D. Due to the under-representation of the BM, the framework used a paired training strategy, where the cubic regions that are centered by randomly selected pairs of positive and negative samples (i.e., BM and candidates that are not BM) form the training data batches. The training batches were then augmented on the fly (via random translations, rotations, gamma corrections, and elastic deformations [40]), and binary cross-entropy loss was minimized iteratively to optimize the network's classification performance (see FIG. 4).

Forced Latent Space Mapping Discussion. Forced latent space mappings operations were developed within the study.

The study considered the generalizability of an AI model might be conceptualized by specifying the underlying data presentation held by the model. Domain shift is the cause of reduced generalizability [26], [41], which describes a mismatch between the training and new (i.e., test, unseen) data underlying probabilistic distribution functions (PDFs). Understanding the training data's PDF by observing the model's latent space was not an intuitive task, as the latent space mappings (LSMs) of modern DNNs are commonly not formulated to convey a specific distribution pattern. The study hypothesized that if the data could be forced into a predefined PDF held by the model during its training, then the unseen data PDF divergence from this distribution could be quantified, leading to a precursor for predicting the model's generalizability on the fly.

For a training dataset x and a corresponding output y (with unknown PDFs of P(x) and P(y) respectively)), the study (1) mapped a trained classifier network x (i.e., CropNet) into hidden layer outputs (i.e., LSMs) of z₁, z₂, . . . z_{d} with d giving the network depth and (2) produced the network output y approximating y. The hidden layer PDFs were given by posterior distributions of p(z₁|x, y), p(z₂|x, y), . . . p(z_{d}|x, y), and the output PDF was given by p(\tilde{y}). Each [symbol] gave a form of underlying training data representation the model holds; however, the PDFs of the latter layers were more relevant as they represented the information distilled toward the target output. Accordingly, the study referred to p(z_{d}|x, y) as the underlying training data presentation, and LSMs as the latent space mappings of layer d. As mentioned previously, CropNet performs a binary classification task with the classes of 1:BM and 0:No-BM, where the positively labeled part of the training data can be shown as (x₊, y₊). This study aimed to force the underlying representation of only the positive part of the training data, as the BM class is heavily underrepresented in this specific application; the candidate selection stage generates ˜60K candidates for a given 3D dataset where only a minuscule amount of them are BM centers [42]. To force the underlying data presentation of the positive part into a standard multivariate normal distribution (i.e., with zero mean and identity covariance matrix) per Equation 1.

The study introduced a Fréchet Loss Function (FLS) that performed the given approximation during the model's training iteratively. For a given batch of positive samples (z̅⊆z_{d+}), FLS (1) computed the mean (μ_{b}) and covariance matrix (Σ_{b}) of z̅ and (2) returned the Fréchet distance [43] (d²) between the batch's distribution and N(0, I) per Equation 2 with E giving a small floating number to ensure that the square root of Σ_{b} could be computed. Hence, it penalized proportionally to the posterior distribution's divergence from N(0, I). After the training, p(z_{d}+|x₊, y₊) was estimated via multivariate normal distribution N(μ_{f}, Σ_{f}) using the LSMs' final positions without a dimension reduction.

For a given unseen data (e.g., test data), the underlying training data representation of the predicted positive samples (i.e., pseudo positives) were analyzed: The Mahalanobis distances between LSMs coming from pseudo positive samples 2 (with the corresponding network output of \tilde{y}>ψ, where ψ is a network threshold calibrated for a specific BM detection sensitivity based on the training data) and the forced distribution (i.e., N(μ_{f}, Σ_{f})) were computed to give a set D. Finally, the hypothesis that the majority of D were not outliers with regards to the forced distribution was tested by comparing the median of D versus a high quantile (i.e., 95%) chi-square distribution with degrees of freedom given by dim(μ_{f}). If the majority of 2 are outliers, then the given unseen data may differ from the training data in its underlying presentation characteristics; thus, the model might not generalize to the given case properly.

Database. The study database originated from two sources (1) the Ohio State University Wexner Medical Center and (2) the Stanford University School of Medicine Brain Mets Dataset [36]. Two major study selection criteria were that the study (1) should include at least a single BM and (2) should not include a BM with a diameter greater than 15 mm. The OSU dataset was collected retrospectively following Institutional Review Board approval with a waiver of informed consent (institutional IRB ID: 2016H0084). It consisted of 217 post-gadolinium T1-weighted 3D MRI (T1c) exams (contrast agent: gadoterate meglumine—0.1 mmol/kg of body weight) collected from 158 patients with their BM segmentation masks. The Stanford dataset was collected from [36] and filtered (1) by the aforementioned study selection criteria and (2) to include only the T1 gradient-echo post images, giving 72 T1c exams. The data is divided into three groups for the analyses per Table 1.

TABLE 1
Training: 175 T1c exams from 127 randomly selected patients of the OSU dataset (75% of the
OSU patients); 89 patients with one, 29 patients with two, 8 patients with three, and a patient
with four exams. The group's mean BM diameter is 5.64 mm (σ = 2.78 mm), median BM
diameter is 4.72 mm, mean BM volume is 176.57 mm³ (σ = 291.08 mm³), and median BM
volume is 55 mm³.
Test-OSU: 42 T1c exams came from the nonoverlapping 31 patients of the OSU dataset (25%
of the OSU patients); 24 patients with one, 4 patients with two, 2 patients with three and a
patient with four exams. The group's mean BM diameter is 4.55 mm (σ = 1.85 mm), median
BM diameter is 4.10 mm, mean BM volume is 80.61 mm³ (σ = 165.58 mm³), and median BM
volume is 36 mm³.
Test Stanford: The complete set of the Stanford T1c exams. The group's mean BM diameter is
5.13 mm (σ = 2.24 mm), median BM diameter is 4.54 mm, mean BM volume is 120.96 mm³ (σ =
224.45 mm³), and median BM volume is 49 mm³.

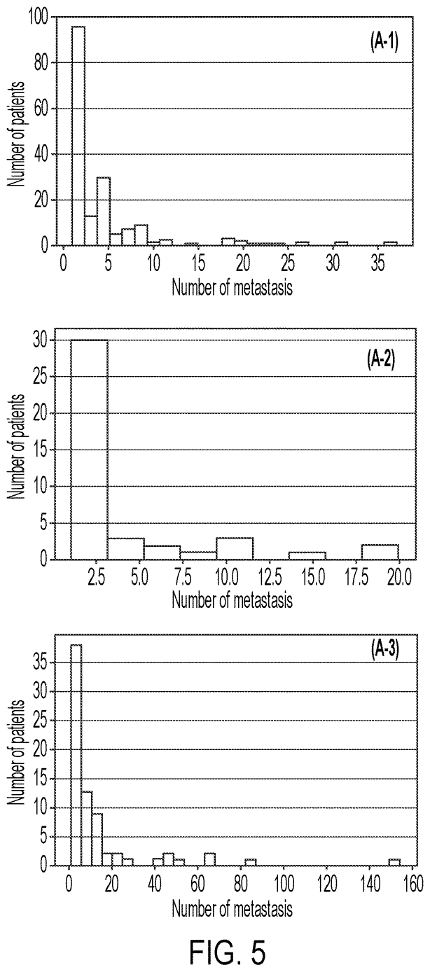

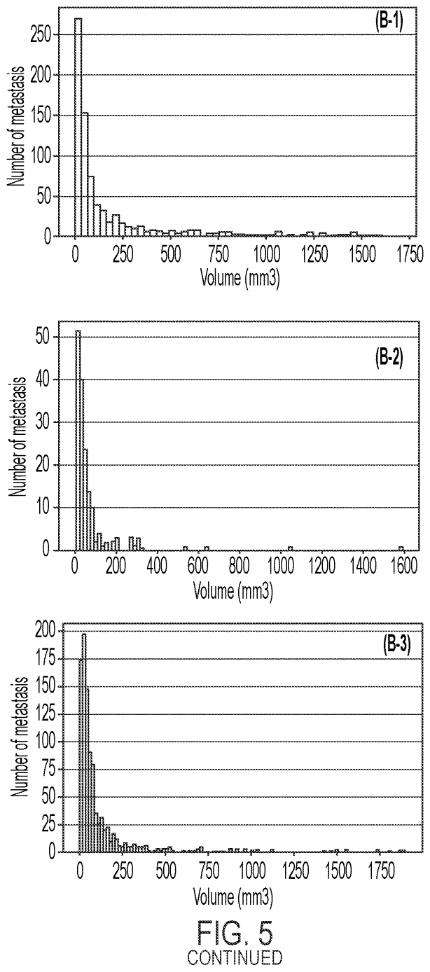

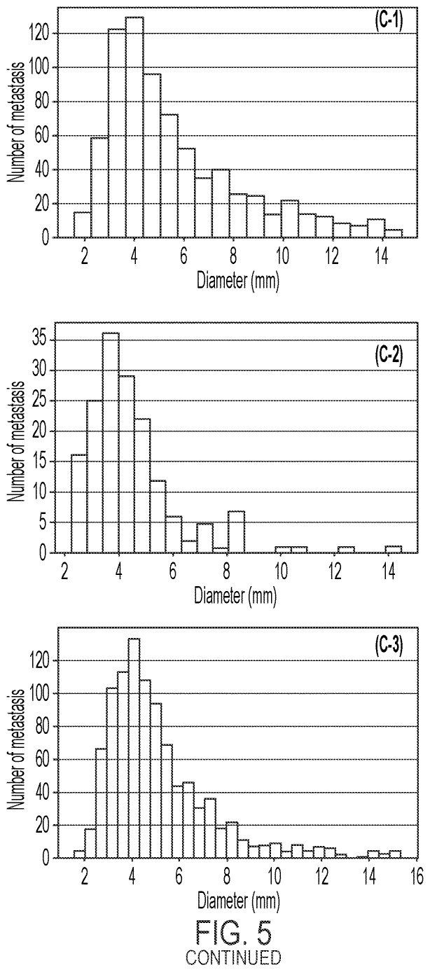

FIG. 5 provides the histograms for the BM (1) count per exam, (2) diameter, and (3) volume for these groups. The spatial distributions of BM for the groups are presented in FIG. 4; the visualization was performed by adopting the strategy from [4] to present BM probability distributions on a template T1c exam.

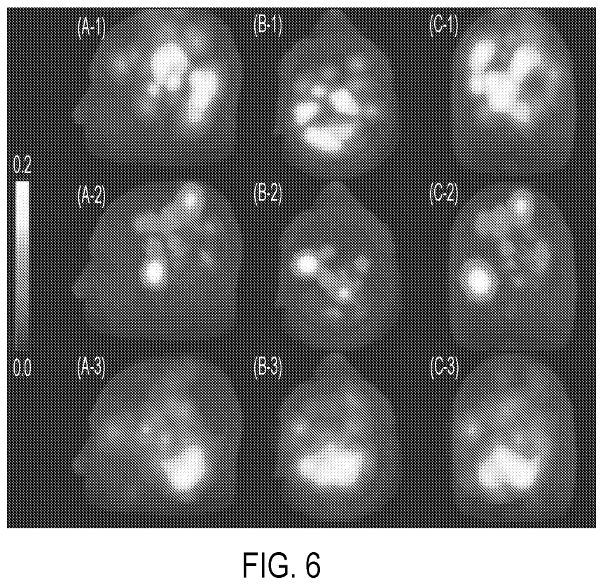

FIG. 6 provides for the BM probability density function's projections. The left sagittal (A), axial (B), and coronal (C) planes are provided for the Train (ABC-1), Test OSU (ABC-2) and Test Stanford (ABC-3) groups.

Validation metric. The average number of false positives-AFP (i.e., mean false BM detection count per exam) in connection with the detection sensitivity (i.e., the percentage of true BMs detected) was used as the validation metric. A tumor was marked as detected if the distance between a framework-generated detection and the tumor center was <1.5 mm. This metric provided a relevant measurement for the algorithm's applicability in real-life deployment scenarios as (1) the sensitivity of a detection system is critical, and (2) the number of false positives needs to be minimized to ensure the system's feasibility. Thus, various BM detection studies (including [44]-[46]) have utilized this metric.

### Results

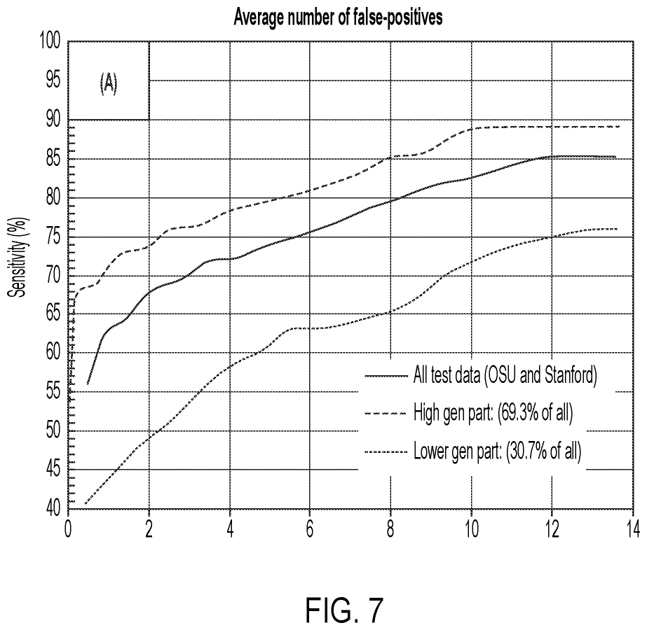

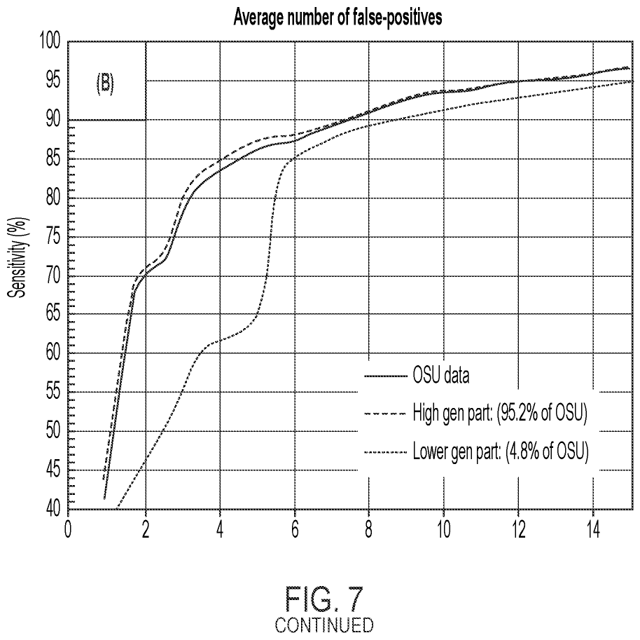

Validation study. FIG. 7 shows the AFP vs. sensitivity for (A) the combination of two test groups, (B) Test-OSU and (C) Test-Stanford. (1) The black curves: the complete set of exams; (2) the blue curves: the subgroup of exams where the model predicted that it generalizes; (3) the red curves: the subgroup of exams where the model predicted its low generalizability.

The BM detection framework was trained using the training group. The candidate selection process generated ˜72K BM candidates per exam, capturing ˜95% of the actual BM centers. The BM classification network, CropNet [4], was modified to produce four-dimensional LSMs as its secondary output (in addition to the BM probability output), as described in the Forced Latent Space Mapping Discussion. The training process optimized the combination of (1) binary cross-entropy loss computed on the BM probability and (2) FLF computed on the LSM outputs. The weights for the loss components were 0.9 and 0.1, respectively, which were determined empirically. The optimization was performed using the Adam algorithm [47], where the learning rate was 0.00005, and the exponential decay rates for the first and second-moment estimates were set as 0.9 and 0.999. The training batch size was set as 128. After the network's training, the threshold value ψ was set for BM detection sensitivity of 90% for the training data.

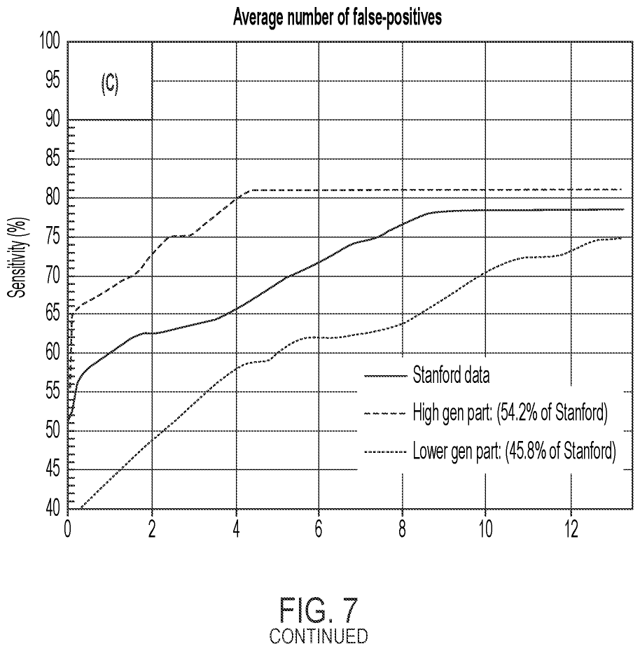

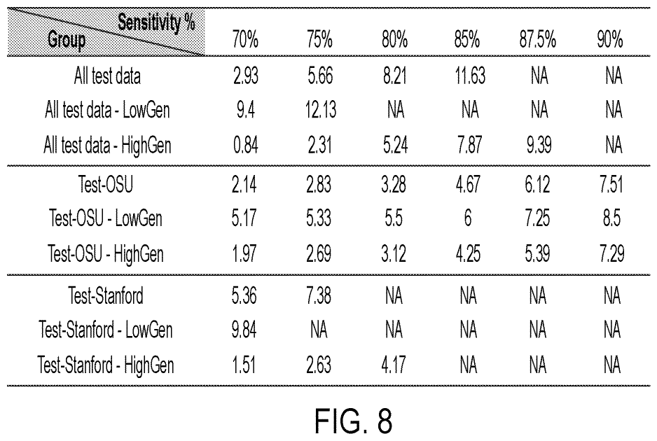

Next, the model was executed on the testing groups (i.e., Test-OSU and Test-Stanford). For each test exam, (1) the model produced the predicted BM locations and (2) the model's predicted generalizability status (i.e., A-the model generalizes or B-not), computed by processing the LSMs of a given exam as previously described. The AFP in connection with the BM detection sensitivity for the subgroups of predicted high and low model generalizability are reported in FIG. 7 and the table of FIG. 8. The model predicted its generalizability low for (1) 2 out of 42 Test-OSU exams (4.8%) and (2) 33 out of 72 Test-Stanford exams (48.5%). For all testing data (i.e., the combination of Test-OSU and Test Stanford), it produced (1) ˜13.5 false positives (FPs) at 76.1% BM detection sensitivity for the low and (2) ˜10.5 FPs at 89.2% BM detection sensitivity for the high generalizability groups respectively.

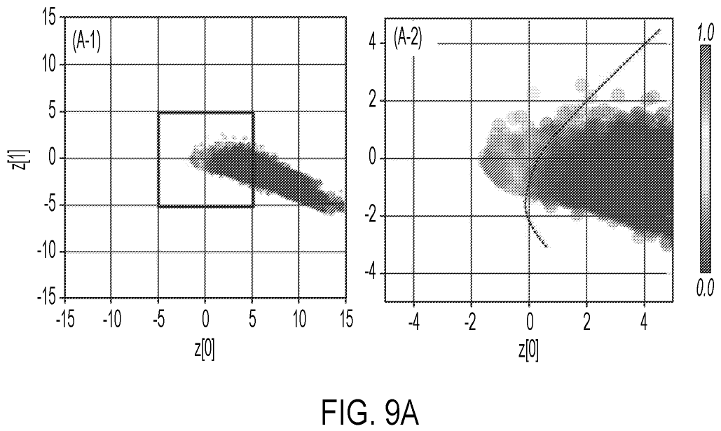

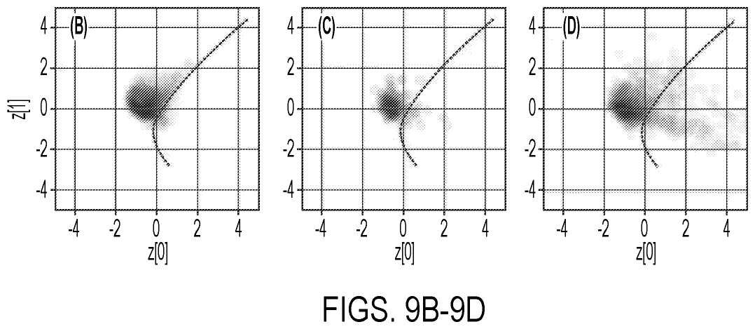

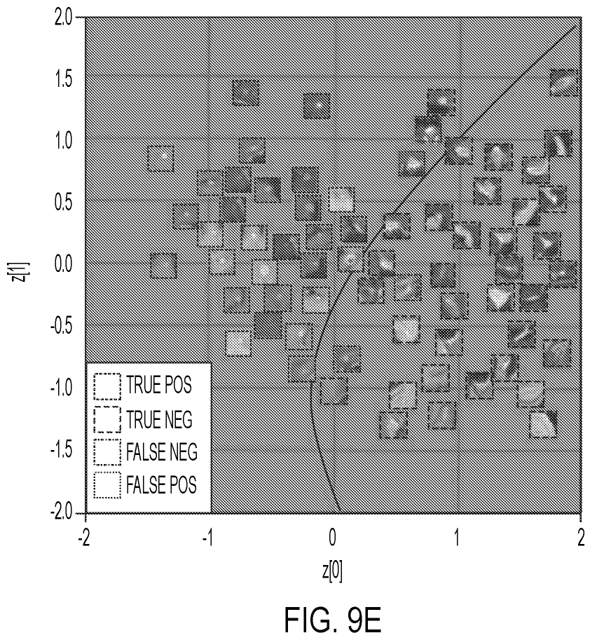

Visualizations of LSMs. FIG. 9 (A-1) shows the network's BM probability output is represented as a heat map for random candidate regions in latent space. FIG. 9 (A-2) shows the decision curve is predicted based on the probability outputs, shown with an orange dashed curve.

FIG. 9 (B) shows training, (C) shows test-OSU, and (D) shows test-Stanford BM LSMs with the predicted decision curve.

In FIGS. 9A-9D, the decision curve (estimated based on the network's BM probability output) is shown along with the LSMs of the actual BMs for the training, Test-OSU and Stanford-OSU groups: The visualization shows the first two dimensions of the LSMs (there were four dimensions in total). The LSMs' average L2 norm and median distance to origin were (1) 1.201 and 1.146 for the training, (2) 1.321 and 1.288 for Test-OSU, and (3) 2.682 and 1.686 for Test-Stanford, respectively.

In FIG. 9E, mid-axial slices of a sample set of candidate cubic regions from the Test-Int group are presented at coordinate positions specified by the first two dimensions of their LSMs (only 2 of the 4 latent space dimensions are used in this visualization for simplicity). True positives: solid squares left of the decision curve, true negatives: solid squares right of the decision curve, false positives: dashed squares left of the decision curve, and false negatives: dashed squares right of the decision squares.

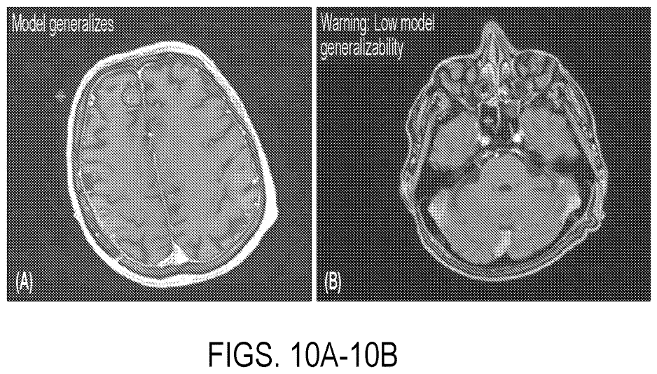

Radiology workflow integration. FIG. 10 shows the locations of the BM and the model's generalization status are overlayed on two different exams by an advanced DICOM viewer; (A) ‘model generalizes’ info is generated by the proposed algorithm, (B) ‘low model generalizability’ warning is generated by the proposed algorithm: the data was from another organization acquired with a scanner, where the training data had no acquisitions from a similar scanner.

The integration of medical AI solutions into radiology workflows was examined in various studies [48]-[50]. In [50], three maturity levels were proposed for radiology workflows that integrate AI; research, production, and feedback. These levels reflect the readiness and infrastructure of an institution, where the readers are referred to referenced paper for further details. However, the study described and adapted the research workflow to present a sample integration of the introduced approach.

At this workflow, imaging modalities (i.e., MRI in this scenario) send acquired images to a DICOM router distributing received images to pertinent storage locations, such as the PACS or VNA. To benefit from the proposed AI-based algorithm, the radiologist may send images to a DICOM node where the BM detection framework is deployed: In our deployment, the DICOM node is a virtual machine running an application composed of a DICOM listener and Python script implementation of the framework. The framework receives the input DICOM images (corresponding to the T1c dataset), processes them, and prepares the results as two Grayscale Softcopy Presentation State (GSPS) objects [51] per Table 2.

TABLE 2
BM detection result GSPS: combining the graphic data (i.e., circles) to present the detected
BM centers in their corresponding DICOM image positions, and textual data to show detected
BMs' identifiers with the algorithm ID.
Model generalization status GSPS: textual data to present the model's generalization status for
the given exam rendered at the upper left side of the exam's slices (see FIG. 10)

After the GSPS objects were generated, they were sent to a separate Research-PACS; thus, the official image records in PACS, as well as patient EMRs, remained intact. The archives in the Research-PACS were accessible by stand-alone advanced DICOM viewers that allow viewing and analyzing BM detection results in connection with their corresponding standard DICOM images.

Discussion AI system's generalizability describes the continuity of its performance acquired from varying geographic, historical, and methodologic settings. Previous literature on this topic has mostly focused on “how” to achieve high generalizability (e.g., via larger datasets, transfer learning, data augmentation, and model regularization schemes) with limited success. Instead, the study aimed to understand “when” the generalizability was achieved: the study developed a formulation for an AI system that can predict its generalizability status for unseen data on-the-fly. The method introduced a model that maps the training data's underlying statistical distribution into multivariate Gaussian, allowing the model to predict its generalizability status for unseen data.

Unlike the current global research on achieving generalizable systems, the exemplary system and method find if the model system will generalize. Thus, it can warn its users during the deployment if the given test data does not convey the underlying presentation it was trained with. This type of self-awareness for an AI system is novel and highly needed.

The methodology was presented on the Brain Metastases detection system (convolutional neural network using AI system) using an MRI dataset collected by the OSU (private) and Stanford (public). The approach could be extended to a variety of AI applications used in a wide range of industries (e.g., energy, finance, automotive).

Example Computing Environment. An exemplary computing environment that may implement the anti-malware server or client device may include various numerous computing devices environments or configurations. Examples of computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc., that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media, including memory storage devices.

An exemplary system, in its most basic configuration, may include at least one processing unit and memory. A processing unit may include one or more processing elements (e.g., reduced instruction set computing (RISC) cores or complex instruction set computing (CISC) cores, etc.) that can execute computer-readable instructions to perform a pre-defined task or function. Depending on the exact configuration and type of computing device, memory may be volatile (such as random-access memory (RAM)), non-volatile (such as read-only memory (ROM), flash memory, etc.), or some combination of the two.

The computing device may have additional features/functionality. For example, the computing device may include additional storage (removable and/or non-removable), including, but not limited to, magnetic or optical disks or tape.

The computing device may include a variety of computer-readable media. Computer-readable media can be any available media that can be accessed by the device and includes both volatile and non-volatile media, removable and non-removable media.

Computer storage media include volatile and non-volatile, and removable and non-removable media implemented in any method or technology for storage of information such as computer-readable instructions, data structures, program modules, or other data. Memory, removable storage, and non-removable storage are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. Any such computer storage media may be part of the computing device.

The computing device may contain communication connection(s) that allow the device to communicate with other devices. The computing device may also have input device(s) such as a keyboard, mouse, pen, voice input device, touch input device, etc. Output device(s) such as a display, speakers, printer, etc., may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

It must also be noted that, as used in the specification and the appended claims, the singular forms “a,” “an,” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The following patents, applications, and publications, as listed below and throughout this document, describes various application and systems that could be used in combination the exemplary system and are hereby incorporated by reference in their entirety herein.
[1] I. El Naga, M. A. Haider, M. L. Giger, and R. K. Ten Haken, “Artificial Intelligence: reshaping the practice of radiological sciences in the 21st century,” Br. J. Radiol., vol. 93, no. 1106, p. 20190855, 2020.
[2] S. K. Zhou et al., “A review of deep learning in medical imaging: Imaging traits, technology trends, case studies with progress highlights, and future promises,” Proc. IEEE, vol. 109, no. 5, pp. 820-838, 2021.
[3] S. Jang et al., “Deep learning-based automatic detection algorithm for reducing overlooked lung cancers on chest radiographs,” Radiology, vol. 296, no. 3, pp. 652-661, 2020.
[4] E. Dikici et al., “Automated Brain Metastases Detection Framework for T1-Weighted Contrast-Enhanced 3D MRI,” IEEE J. Biomed. Heal. Informatics, p. 1, 2020.
[5] E. J. Hwang et al., “Development and validation of a deep learning-based automatic detection algorithm for active pulmonary tuberculosis on chest radiographs,” Clin. Infect. Dis., vol. 69, no. 5, pp. 739-747, 2019.
[6] X. Liu, K. Chen, T. Wu, D. Weidman, F. Lure, and J. Li, “Use of multimodality imaging and artificial intelligence for diagnosis and prognosis of early stages of Alzheimer's disease,” Transl. Res., vol. 194, pp. 56-67, 2018.
[7] G. Muscogiuri et al., “Artificial intelligence in coronary computed tomography angiography: from anatomy to prognosis,” Biomed Res. Int., vol. 2020, 2020.
[8] S. Gupta and Y. Kumar, “Cancer prognosis using artificial intelligence-based techniques,” SN Comput. Sci., vol. 3, no. 1, pp. 1-8, 2022.
[9] N. L. Eun et al., “Texture analysis with 3.0-T MRI for association of response to neoadjuvant chemotherapy in breast cancer,” Radiology, vol. 294, no. 1, pp. 31-41, 2020.
[10] D. Russo et al., “Prediction of chemo-response for serous ovarian cancer using DNA methylation patterns with deep machine learning (AI),” Gynecol. Oncol., vol. 162, p. S240, 2021.
[11] C. Li et al., “Deep learning-based AI model for signet-ring cell carcinoma diagnosis and chemotherapy response prediction in gastric cancer,” Med. Phys., vol. 49, no. 3, pp. 1535-1546, 2022.
[12] F. Maleki, K. Ovens, R. Gupta, C. Reinhold, A. Spatz, and R. Forghani, “Generalizability of Machine Learning Models: Quantitative Evaluation of Three Methodological Pitfalls,” arXiv Prepr. arXiv 2202.01337, 2022.
[13] H. Salehinejad et al., “A real-world demonstration of machine learning generalizability in the detection of intracranial hemorrhage on head computerized tomography,” Sci. Rep., vol. 11, no. 1, pp. 1-11, 2021.
[14] V. M. T. de Jong, K. G. M. Moons, M. J. C. Eijkemans, R. D. Riley, and T. P. A. Debray, “Developing more generalizable prediction models from pooled studies and large clustered data sets,” Stat. Med., vol. 40, no. 15, pp. 3533-3559, 2021.
[15] A. C. Justice, K. E. Covinsky, and J. A. Berlin, “Assessing the generalizability of prognostic information,” Ann. Intern. Med., vol. 130, no. 6, pp. 515-524, 1999.
[16] T. Eche, L. H. Schwartz, F.-Z. Mokrane, and L. Dercle, “Toward Generalizability in the Deployment of Artificial Intelligence in Radiology: Role of Computation Stress Testing to Overcome Underspecification,” Radiol. Artif Intell., vol. 3, no. 6, p. e210097, 2021.
[17] J. Futoma, M. Simons, T. Panch, F. Doshi-Velez, and L. A. Celi, “The myth of generalisability in clinical research and machine learning in health care,” Lancet Digit. Heal., vol. 2, no. 9, pp. e489-e492, 2020.
[18] B. Neyshabur, S. Bhojanapalli, D. McAllester, and N. Srebro, “Exploring generalization in deep learning,” Adv. Neural Inf Process. Syst., vol. 30, 2017.
[19] D. Anderson and K. Burnham, “Model selection and multi-model inference,” Second NY Springer-Verlag, vol. 63, no. 2020, p. 10, 2004.
[20] A. D'Amour et al., “Underspecification presents challenges for credibility in modern machine learning,” arXiv Prepr. arXiv 2011.03395, 2020.
[21] S. Mutasa, S. Sun, and R. Ha, “Understanding artificial intelligence based radiology studies: What is overfitting?,” Clin. Imaging, vol. 65, pp. 96-99, 2020.
[22] C. Shorten and T. M. Khoshgoftaar, “A survey on image data augmentation for deep learning,” J. big data, vol. 6, no. 1, pp. 1-48, 2019.
[23] F. Zhuang et al., “A comprehensive survey on transfer learning,” Proc. IEEE, vol. 109, no. 1, pp. 43-76, 2020.
[24] R. Moradi, R. Berangi, and B. Minaei, “A survey of regularization strategies for deep models,” Artif Intell. Rev., vol. 53, no. 6, pp. 3947-3986, 2020.
[25] E. W. Steyerberg and F. E. Harrell, “Prediction models need appropriate internal, internal-external, and external validation,” J. Clin. Epidemiol., vol. 69, pp. 245-247, 2016.
[26] E. Kondrateva, M. Pominova, E. Popova, M. Sharaev, A. Bernstein, and E. Burnaev, “Domain shift in computer vision models for MRI data analysis: an overview,” in Thirteenth International Conference on Machine Vision, 2021, vol. 11605, pp. 126-133.
[27] H.-J. Yoo, “Deep convolution neural networks in computer vision: a review,” IEIE Trans. Smart Process. Comput., vol. 4, no. 1, pp. 35-43, 2015.
[28] V. Sze, Y.-H. Chen, T.-J. Yang, and J. S. Emer, “Efficient processing of deep neural networks: A tutorial and survey,” Proc. IEEE, vol. 105, no. 12, pp. 2295-2329, 2017.
[29] L. Oakden-Rayner, “Exploring Large-scale Public Medical Image Datasets,” Acad. Radiol., vol. 27, no. 1, pp. 106-112, 2019.
[30] N. L. S. T. R. Team, “The national lung screening trial: overview and study design,” Radiology, vol. 258, no. 1, pp. 243-253, 2011.
[31] A. E. Flanders et a., “Construction of a machine learning dataset through collaboration: the RSNA 2019 brain CT hemorrhage challenge,” Radiol. Artif Intell., vol. 2, no. 3, 2020.
[32] P. Dluhos et al., “Multi-center Machine Learning in Imaging Psychiatry: A Meta-Model Approach,” Neuroimage, vol. 155, 2017.
[33] K. Simonyan and A. Zisserman, “Very deep convolutional networks for large-scale image recognition,” arXiv Prepr. arXiv 1409.1556, 2014.
[34] K. He, X. Zhang, S. Ren, and J. Sun, “Deep residual learning for image recognition,” in Proceedings of the IEEE conference on computer vision and pattern recognition, 2016, pp. 770-778.
[35] M. J. Willemink et al., “Preparing medical imaging data for machine learning,” Radiology, vol. 295, no. 1, p. 4, 2020.
[36] C. for Artificial Intelligence in Medicine & Imaging, “BrainMetShare, available online at: https://aimi.stanford.edu/brainmetshare, last accessed on 11.05.2021.”.
[37] E. Dikici, M. Bigelow, R. D. White, B. S. Erdal, and L. M. Prevedello, “Constrained generative adversarial network ensembles for sharable synthetic medical images,” J Med. Imaging, vol. 8, no. 2, p. 24004, 2021.
[38] E. Tong, K. L. McCullagh, and M. Iv, “Advanced imaging of brain metastases: from augmenting visualization and improving diagnosis to evaluating treatment response,” Front. Neurol., vol. 11, p. 270, 2020.
[39] T. Lindeberg, “Scale selection properties of generalized scale-space interest point detectors,” J. Math. Imaging Vis., vol. 46, no. 2, pp. 177-210, 2013.
[40] P. Y. Simard, D. Steinkraus, and J. C. Platt, “Best practices for convolutional neural networks applied to visual document analysis,” in Seventh International Conference on Document Analysis and Recognition, 2003. Proceedings., 2003, vol. 1, pp. 958-963.
[41] E. H. P. Pooch, P. L. Ballester, and R. C. Barros, “Can we trust deep learning models diagnosis? The impact of domain shift in chest radiograph classification,” arXiv Prepr. arXiv 1909.01940, 2019.
[42] E. Dikici, X. V Nguyen, M. Bigelow, and L. M. Prevedello, “Augmented networks for faster brain metastases detection in T1-weighted contrast-enhanced 3D MRI,” Comput. Med. Imaging Graph., vol. 98, p. 102059, 2022.
[43] D. C. Dowson and B. V Landau, “The Fréchet distance between multivariate normal distributions,” J. Multivar. Anal., vol. 12, no. 3, pp. 450-455, 1982.
[44] O. Charron, A. Lallement, D. Jarnet, V. Noblet, J.-B. Clavier, and P. Meyer, “Automatic detection and segmentation of brain metastases on multimodal MR images with a deep convolutional neural network,” Comput. Biol. Med, vol. 95, 2018.
[45] E. Grovik, D. Yi, M. Iv, E. Tong, D. Rubin, and G. Zaharchuk, “Deep learning enables automatic detection and segmentation of brain metastases on multisequence MRI,” J Magn. Reson. Imaging, vol. 51, 2019.
[46] Z. Zhou et al., “Computer-aided detection of brain metastases in T1-weighted MRI for stereotactic radiosurgery using deep learning single-shot detectors,” Radiology, vol. 295, no. 2, pp. 407-415, 2020.
[47] D. Kingma and J. Ba, “Adam: A Method for Stochastic Optimization,” Int. Conf Learn. Represent., 2014.
[48] E. Ranschaert, L. Topff, and O. Pianykh, “Optimization of Radiology Workflow with Artificial Intelligence,” Radiol. Clin., vol. 59, no. 6, pp. 955-966, 2021.
[49] J. H. Sohn et al., “An open-source, vender agnostic hardware and software pipeline for integration of artificial intelligence in radiology workflow,” J. Digit. Imaging, vol. 33, no. 4, pp.
[50] E. Dikici, M. Bigelow, L. M. Prevedello, R. D. White, and B. S. Erdal, “Integrating AI into radiology workflow: levels of research, production, and feedback maturity,” J. Med. Imaging, vol. 7, no. 1, p. 16502, 2020.
[51] National Electrical Manufacturers Association (NEMA), “Digital Imaging and Communications in Medicine (DICOM)—Supplement 33: Grayscale Softcopy Presentation State (GSPS) Storage,” Rosslyn, V A, 1999.
[52] U.S. Patent Publication No. 20220051402

1. A method to train a machine learning or artificial intelligence (ML/AI) classification model, the method comprising:
receiving, by a processor of a first computing device, a training data set;
training or re-training, by the processor, via a latent-space-associated loss function, a classification model (or a trained classification model) to generate a trained classification model (or a re-trained classification model), wherein the training or re-training applies a latent space mapping that adjust parameters of the classification model that forced the training data set to a probabilistic distribution defined in the latent-space-associated loss function; and
outputting, by the processor, the trained classification model, wherein the trained classification model is used in a classification application.

2. The method of claim 1, wherein the training or re-training via the latent-space-associated loss function includes:
iteratively adjusting parameters of the classification model for a plurality of data in the training data set by, for a given data of the plurality of data:
calculating parameters of the probabilistic distribution;
calculating a distance measure between the probabilistic distribution and the given data; and
penalizing proportionally a divergence from the probabilistic distribution.

3. The method of claim 2 further comprising:
evaluating, by a processor of a second computing device, a data set by:
calculating a distance measure of the data set in the probabilistic distribution; and
comparing the probabilistic distribution of the data set to the probabilistic distribution of the training data set, wherein the comparison is used to determine the data set as an outlier of the training data set.

4. The method of claim 3, wherein the comparison determines whether the probabilistic distribution of the data set is greater than a pre-defined deviation to probabilistic distribution of the training data set.

5. The method of claim 4, wherein the evaluation causes the second computing device to at least one:
(i) indicate the data set as an outlier;
(ii) indicate the data set as having a high confidence of being an outlier data set; and
(iii) reject output of the trained classification model from the second computing device.

6. The method of claim 5 further comprising:
generating a report of the evaluation.

7. The method of claim 6, wherein the parameters of the probabilistic distribution include a mean parameter and a covariance matrix parameter for a Gaussian distribution.

8. The method of claim 7, wherein the distance measure is a Fréchet distance function.

9. A method to generate a generalization metric for an AI classification model trained using data from a first measurement system, the method comprising:
receiving a data set for an AI model, wherein the data set was acquired from (i) a second measurement system type or (ii) a second measurement system having a different measurement protocol to that of the first measurement system;
calculating a distance measure of the data set in a latent-space associated probabilistic distribution, wherein the AI classification model was trained in a training or re-training operation using a latent-space-associated loss function, wherein the training or re-training operation applies a latent space mapping that adjusts parameters of the AI classification model that forced a training data set to the latent-space associated probabilistic distribution defined in the latent-space-associated loss function;
determining a generalization metric by comparing the probabilistic distribution of the data set to the probabilistic distribution of the training data set; and
outputting the determined generalization metric, wherein the generalization metric is used to at least one of (i) indicate the data set as an outlier, (ii) indicate the data set as having a high confidence of being an outlier data set, and (iii) reject output of the trained classification model.

10. The method of claim 9, wherein the training or re-training via the latent-space-associated loss function included:
iteratively adjusting parameters of the classification model for a plurality of data in the training data set by, for a given data of the plurality of data:
calculating parameters of the probabilistic distribution;
calculating the distance measure between the probabilistic distribution and the given data; and
penalizing proportionally a divergence from the probabilistic distribution.

11. The method of claim 10, wherein the parameters of the probabilistic distribution include a mean parameter and a covariance matrix parameter for a Gaussian distribution.

12. The method of claim 11, wherein the distance measure is a Fréchet distance function.

13. A system comprising:
a processor; and
a memory having instructions stored thereon, wherein execution of the processor causes the processor to:
receive, by the processor, a training data set;
train or re-train, by the processor, via a latent-space-associated loss function, a classification model (or a trained classification model) to generate a trained classification model (or a re-trained classification model), wherein the training or re-training applies a latent space mapping that adjust parameters of the classification model that forced the training data set to a probabilistic distribution defined in the latent-space-associated loss function; and
output, by the processor, the trained classification model, wherein the trained classification model is used in a classification application.

14. The system of claim 13, wherein the training or re-training is performed on a first computing device, and wherein a generalization metric for an AI classification model is generated at a second computing device.

15. A non-transitory computer-readable medium having instructions stored thereon, wherein the instructions when executed by a processor cause the processor to:
receive, by the processor, a training data set;
train or re-train, by the processor, via a latent-space-associated loss function, a classification model (or a trained classification model) to generate a trained classification model (or a re-trained classification model), wherein the training or re-training applies a latent space mapping that adjust parameters of the classification model that forced the training data set to a probabilistic distribution defined in the latent-space-associated loss function; and
output, by the processor, the trained classification model, wherein the trained classification model is used in a classification application.

16. (canceled)

17. The non-transitory computer-readable medium of claim 15, wherein the training or re-training via the latent-space-associated loss function includes:
iteratively adjusting parameters of the classification model for a plurality of data in the training data set by, for a given data of the plurality of data:
calculating parameters of the probabilistic distribution;
calculating a distance measure between the probabilistic distribution and the given data; and
penalizing proportionally a divergence from the probabilistic distribution.

18. The non-transitory computer-readable medium of claim 17, wherein the instructions when executed by a processor further cause the processor to:
evaluate, by the processor, a data set by:
calculate a distance measure of the data set in the probabilistic distribution; and
compare the probabilistic distribution of the data set to the probabilistic distribution of the training data set, wherein the comparison is used to determine the data set as an outlier of the training data set.

19. The non-transitory computer-readable medium of claim 18, wherein the comparison determines whether the probabilistic distribution of the data set is greater than a pre-defined deviation to probabilistic distribution of the training data set.

20. The non-transitory computer-readable medium of claim 18, wherein the instructions when executed by a processor further cause the processor to:
generate a report of the evaluation.
